(19) United States
(12) Patent Application Publication
(10) Pub. No.: US 2026/0305644 A1
(43) Pub. Date: Oct. 8, 2026

(54) PROCESS AND APPARATUS FOR PRODUCTION OF DECAFFEINATED RAW COFFEE BEAN EXTRACTS AND CAFFEINE USING ADSORBER RESINS AND DICHLOROMETHANE, AND CORRESPONDING USES

(71) Applicant: ANKA ANGEWANDTE KAFFEETECHNOLOGIE GMBH, Bremen (DE)

(72) Inventors: Oliver SÜSSE-HERRMANN, Hude (DE); Jan Christoph SCHWITAL, Hamburg (DE); Felix PESCHUTTER, Buchholz in der Nordheide (DE); Julia DESQUÉ DE GUZMAN, Bremen (DE)

(21) Appl. No.: 19/106,921

(22) PCT Filed: Aug. 28, 2023
(86) PCT No.: PCT/EP2023/073566

§ 371 Date: Feb. 26, 2025

(30) Foreign Application Priority Data
Aug. 26, 2022 (EP) 22192457.4

(51) Int. Cl. A23F 5/02; A23F 5/18; A47J 31/44

(52) U.S. Cl. CPC A23F 5/02; A23F 5/185; A47J 31/4403

(57) ABSTRACT

What is described is a process for producing decaffeinated green coffee beans. One process step here comprises the extraction of caffeine from green coffee beans by means of an aqueous extraction liquid, a further process step comprises the binding of caffeine from the extraction liquid on an adsorber resin, and a further process step comprises the dissolving of caffeine from the caffeine-laden adsorber resin with dichloromethane (DCM).

The present invention relates to a process for producing decaffeinated green coffee beans. One process step here comprises the extraction of caffeine from green coffee beans by means of an aqueous extraction liquid, a further process step comprises the binding of caffeine from the extraction liquid on an adsorber resin, and a further process step comprises the dissolving of caffeine from the caffeine-laden adsorber resin with dichloromethane (DCM).

The present invention additionally relates to an apparatus for production of decaffeinated green coffee beans in a process of the invention. The present invention also relates to the use of an apparatus of the invention for performance of a process of the invention, to the use of dichloromethane for removal of caffeine from an adsorber resin, and to the use of an adsorber resin for adsorbing caffeine from a caffeine-enriched aqueous extraction liquid in a process for producing decaffeinated green coffee beans.

The invention is defined in its various aspects in the appended claims; particular definitions of terms are included in the description that follows. Details and preferred embodiments of the process of the invention, the apparatus of the invention and the uses of the invention will each be apparent from the appended claims and from the description that follows.

The decaffeination of green coffee beans is a widely used process for producing decaffeinated coffee, and for production of caffeine or caffeine concentrates. Green coffee beans are typically decaffeinated in an extraction process. The extraction processes can be roughly divided into three different classes in terms of the extractants used.

A decaffeination process that has long been known is based on the extraction of caffeine from green coffee beans by means of organic solvents such as DCM or ethyl acetate.

In addition, decaffeination processes in which water or aqueous solutions are used as extractants have been developed. These include the “Swiss Water Decaffeination” process and the “French Water Decaffeination” process.

A further standard extractant for decaffeination of green coffee beans is carbon dioxide, in liquid or supercritical form.

The basis of all the aforementioned decaffeination processes is that the extractants used are suitable for leaching or extracting caffeine out of green coffee beans. However, green coffee beans contain not only caffeine but also a multitude of other substances, some of which are responsible for giving the coffee its characteristic taste. There is thus a need for decaffeination processes in which caffeine is removed selectively from green coffee beans such that the other coffee constituents at least largely remain in the green coffee beans.

The coffee constituents can be divided schematically into two classes: the first class of coffee constituents consists of polar constituents having good water solubility; the second class of coffee constituents consists of nonpolar substances of low water solubility. Although caffeine in this context belongs more to the second group of nonpolar substances, it has a feature that not an inconsiderable portion thereof is also soluble in water. Decaffeination processes in which organic nonpolar solvents such as DCM or ethyl acetate are used as extractants are thus of good suitability for removal of caffeine from green coffee beans. But these processes also have disadvantages unless specific and complex measures that counteract these disadvantages are taken.

A first disadvantage is that not only caffeine but also other nonpolar coffee constituents are extracted from the green coffee beans. These especially include nonpolar constituents, some of which are also relevant in respect of the taste of coffee, i.e. what are called the flavorings or aromas. The effect of (direct) extraction of caffeine from green coffee beans with organic nonpolar solvents is thus that not only caffeine but also other coffee constituents are extracted from the green coffee beans. In relation to the retention of flavor properties in the resulting decaffeinated green coffee beans and successor products thereof, these decaffeination processes are thus inferior to decaffeination processes using highly selective extractants, for example liquid carbon dioxide.

A second disadvantage of decaffeination processes in which organic solvents such as DCM or ethyl acetate as extractant are directly contacted with green coffee beans lies in disadvantageous extraction characteristics of the resulting successor products. Especially in the case of successor products in the form of single-portion systems such as coffee capsules, very long extraction times are frequently observed here, which can lead to complete blockage of coffee machines.

A further disadvantage lies in consumer perception. Even though decaffeination processes in which organic solvents such as DCM or ethyl acetate as extractant are directly contacted with green coffee beans are fundamentally benign owing to low residual contents of the solvents used after roasting, they are nevertheless perceived sometimes negatively by consumers, which leads to disadvantages in the marketing of the products.

Decaffeination by means of liquid carbon dioxide does result in coffee products having high flavor quality owing to the high selectivity of the extractant for caffeine, but likewise has certain disadvantages. These disadvantages especially include the high energy expenditure and costs needed to extract a desired amount of caffeine from the green coffee beans. For those reasons too, decaffeination processes by means of liquid carbon dioxide are performed on an industrial scale only in isolated cases. Decaffeination by means of supercritical carbon dioxide is likewise performed only in very isolated cases, since this process is also very costly.

Decaffeination processes with aqueous extraction solutions extract primarily polar constituents from the green coffee beans, such that polar coffee constituents such as acids, minerals and polar aromas (e.g. chlorogenic acids, amino acids, sugars and water-soluble peptides) are transferred to the aqueous extraction liquid. Caffeine is extracted from the green coffee beans with only low selectivity. Nonpolar aromas, vitamins, lipids and other characteristic constituents of the green coffee remain largely in the green coffee beans. Even in the case of aqueous extraction processes, a mixture of extracted coffee constituents is thus always obtained.

There are currently essentially two methods being employed in industry for separation of caffeine from an aqueous extraction solution.

A first method is to subject the caffeinated aqueous extraction liquid to a liquid-liquid extraction with organic solvents such as dichloromethane (DCM). This process is disadvantageous in that the aqueous extraction liquid comes into direct contact with organic solvents such as DCM. DCM is soluble in water in a not inconsiderable amount, and so a proportion of the DCM goes into the aqueous extraction liquid in the liquid-liquid extraction. If such a process were to be performed in a simple cycle process, i.e. the aqueous extraction liquid were to be passed through the green coffee beans again after the liquid-liquid extraction with DCM, DCM dissolved in the aqueous extraction liquid would come into direct contact with the green coffee beans. This is undesirable and disadvantageous for the reasons given above. Moreover, in a disadvantageous manner, a liquid-liquid extraction with organic solvents such as dichloromethane (DCM) requires large volumes of these solvents in order to free the aqueous extractant from caffeine to a sufficient degree.

A second method of removing caffeine from an aqueous extraction solution is to use adsorbents that adsorb caffeine from the aqueous extraction solution. Known processes for this purpose use activated carbon filters in particular, on which the caffeine is bound. However, it is particularly disadvantageous here that the caffeine can then be separated (desorbed) from the adsorbents with great difficulty, if at all, and so isolation of caffeine or caffeine extracts is difficult or impossible. Moreover, relevant fractions of other valuable coffee constituents are also bound to the adsorber materials used and not utilized further, i.e. more particularly are not fed back to the decaffeinated green coffee beans. This ultimately leads to a disadvantageous loss of quality of the resulting decaffeinated green coffee beans. It is also frequently possible to use the adsorbents employed only once, which is undesirable from economic and environmental points of view.

There are known processes in which adsorber materials are used in order to adsorb the substances present in the aqueous extraction liquid. Some of these processes are listed hereinafter:

WO 2014/072282 A1 discloses a process for obtaining caffeine and bioactive substances from coffee by contacting a coffee extract with an adsorber in order to adsorb caffeine and bioactive substances, and then to obtain the adsorbed substances by contacting the adsorber with an aqueous solution and to collect at least two fractions of aqueous solution.

DE 2600492 A1 discloses a process for decaffeinating aqueous extracts of plant materials, which is executed by contacting the extract with a hydrophobic polymer resin having a dipole moment of less than about 2.0 debye, which results in adsorption of caffeine and other soluble constituents by the resin; separating the resin and the decaffeinated extract; leaching the resin with the caffeine adhering thereon and the other soluble constituents adhering thereon with water in order to remove caffeine.

DE 2832267 A1 discloses a process for removing caffeine from green coffee beans, where the beans are extracted with an aqueous liquid and the resultant extract is treated with a synthetic polymer resin that preferably adsorbs caffeine, characterized in that the synthetic polymer resin to be employed is of the type that can be obtained by polymerization or copolymerization of monomers containing aromatic ring systems and acid groups, and as a result of which, moreover, the ratio of the total adsorption capacity for caffeine to the total ion exchange capacity is greater than about 1 and less than about 25, and lies preferably between 5 and 15. There is further disclosure of a process for regenerating the caffeine-laden resin, which is characterized in that the laden resin is first rinsed with water at a temperature between 0° C. and room temperature to extract a desired percentage of solids other than caffeine, and then rinsed with water at a temperature between 50° C. and 100° C. to extract a desired percentage of caffeine.

EP 0 776 607 B1 discloses the use of a polymer molecularly imprinted with caffeine for decaffeination of a coffee extract and a process for extracting caffeine from an aqueous extract that has been obtained from green or roasted coffee beans, wherein the extract is contacted with an imprinted polymer that has noncovalent recognition sites for caffeine and is capable of selectively removing caffeine from an aqueous extract, which results in removal of caffeine from said extract.

GB 1 488 340 A discloses a process for decaffeinating green coffee by means of an extractant having high specificity for caffeine, wherein this extractant is an aqueous extraction solution containing soluble constituents of green coffee excluding caffeine.

EP 0 612 744 B1 discloses a process for decaffeinating green coffee and a process for recovering caffeine from caffeine-laden activated carbon. The caffeine is recovered from caffeine-laden activated carbon via contacting of the laden activated carbon with methyl ethyl ketone, ethyl acetate, dichloromethane or a mixture of methyl ethyl ketone and ethyl acetate.

FR 2 433 359 A1 discloses a process for decaffeinating green or roasted coffee and a process for removing caffeine from aqueous coffee extract by means of adsorber resins, wherein not only caffeine but also other solids extracted from the coffee are adsorbed on the adsorber resins used.

However, even these published water decaffeination processes have certain disadvantages.

One of these disadvantages is that the adsorber materials in some cases have to be produced in a very costly and inconvenient manner; therefore, the processes have not become established at least to date on an industrial scale (cf. EP 0 776 607 B1).

Moreover, although the cited published processes and adsorber materials are suitable for removing caffeine from an aqueous extraction solution, none of the cited processes is sufficiently suitable for providing caffeine or caffeine extract as a product of value. In particular, the (selective) desorption of caffeine bound to the adsorber material constitutes a significant challenge. For instance, in the treatment of the adsorber material that has been discussed in some cases, the bound caffeine is not removed selectively, but what is instead removed is a mixture of caffeine and other coffee constituents. In some processes, complex and therefore inefficient protocols are used, in which the adsorber material is rinsed repeatedly with water at different temperature. Although the rinse fractions thus obtained then have a certain caffeine concentration gradient, such protocols nevertheless seem rather unsuitable for an industrial scale. The effect of this at present is that aqueous extraction processes that make use of an adsorber material for removal of the caffeine from the extraction liquid are disadvantageous.

There is therefore still a need in industry for decaffeination processes for production of decaffeinated green coffee beans that are both efficient and meet the increased consumer demands. Ideally, both decaffeinated green coffee beans in high flavor quality and caffeine or caffeine extract should be producible here as product. It was a primary object of the present invention to specify such processes and corresponding apparatuses for the production of decaffeinated green coffee beans and to alleviate or to eliminate the disadvantages of the known processes. Further objects of the present invention are associated with the primary object; they will be apparent from the description that follows.

The primary and further objects are achieved by the present invention. The present invention, in its diverse aspects and categories, relates in particular to:
a process for producing decaffeinated green coffee beans,
a corresponding apparatus for production of decaffeinated green coffee beans in a process of the invention,
the use of an apparatus of the invention,
the use of dichloromethane for removal of caffeine from an adsorber resin and
the use of an adsorber resin in a specific process for producing decaffeinated green coffee beans.

The present invention has been successful in particular in providing a process that meets the high demands of the coffee industry and the consumers, and additionally provides, in an efficient and economically viable manner, high-quality decaffeinated green coffee beans that can be processed further to corresponding successor products that are likewise of high quality.

Particular embodiments, aspects or properties that are described or described as preferred in association with any of the diverse aspects and categories of the present invention are also each correspondingly or analogously applicable to the respectively other aspects and categories, and vice versa.

Unless it is impossible or stated otherwise in the individual case, aspects, categories and preferred embodiments of the invention are suitable and intended for combination with other aspects, categories or preferred embodiments of the invention. Combinations with one another of aspects or embodiments that are each identified as preferred will again result in each case in preferred aspects or embodiments of the invention.

In a primary aspect of the present invention, the above-specified objects are achieved, and problems are solved, by a process for producing decaffeinated green coffee beans, comprising the following steps:
(S1) contacting an amount of caffeinated green coffee beans with an aqueous extraction liquid so as to extract caffeine from the caffeinated green coffee beans into the extraction liquid,
(S2) contacting the caffeine-enriched aqueous extraction liquid that arises in step S1 with an adsorber resin so as to bind caffeine from the extraction liquid to the adsorber resin,
(S3) contacting the caffeine-laden adsorber resin that arises in step S2 with dichloromethane so as to dissolve caffeine in the dichloromethane.

The process comprises the specified steps; however, it is possible to perform other process steps before, after or between these steps. The person skilled in the art chooses such additional steps and/or intermediate steps according to the requirements of the individual case.

The process of the invention produces decaffeinated green coffee beans. The word “decaffeinated” has the usual meaning. The term “decaffeinated green coffee beans” in the present text thus means green coffee beans having a lower caffeine content than one gram of caffeine in one kilogram of dry coffee mass (cf. the German law “KaffeeV 2001”); the caffeine content is reduced here compared to untreated (naturally occurring) green coffee beans. A green coffee bean that is subjected to the process of the invention thus has a lower caffeine content after performance of the process than before performance of the process.

The term “green coffee bean” refers to coffee beans from which the fruit skin and fruit flesh (the so-called “pulp”) and the parchment skins and the mucilage thereon have been removed. According to the invention, it is possible to use any green coffee beans (Coffea Arabica, Coffea Canephora var. Robusta and others). Green coffee beans may be preswollen or non-preswollen.

The term “aqueous extraction liquid” in the present text means a water-containing liquid that consists of water preferably at least to an extent of 50% by weight, preferably at least 75% by weight.

In the process of the invention, this aqueous extraction liquid is contacted in step (S1) with an amount of caffeinated green coffee beans, i.e. directly contacted with the green coffee beans. The contacting is effected in such a way that the aqueous extraction liquid extracts caffeine from the caffeinated green coffee beans. For this purpose, and also for the further process steps, the person skilled in the art chooses suitable process parameters in a customary manner, especially temperature, pressure, contacting time, amount of aqueous extraction liquid etc.

The term “extracting” in the present text means the leaching of one or more substances out of an extraction material (i.e., in particular, the green coffee beans to be extracted in accordance with the invention) by means of suitable extractants, especially in step (S1) by means of the aqueous extraction liquid.

The term “adsorber resin” in the present text means a polymeric solid that can adsorb substances. In association with steps (S2) and (S3) of the process of the invention, the term specifically means a resin capable of adsorbing caffeine and possibly other coffee constituents and of desorbing bound caffeine again when contacted with dichloromethane, such that caffeine is dissolved in the dichloromethane. Such specifically suitable adsorber resins are commercially available and may be identified by the person skilled in the art on the basis of simple customary preliminary tests and assessed with regard to their adsorption or desorption properties.

The term “caffeine-laden adsorber resin” means that the adsorber resin has been laden with an amount of caffeine, i.e. the adsorber resin has adsorbed an amount of caffeine. A caffeine-laden adsorber resin that arises in step S2, compared to the adsorber resin used in step S2 and contacted with the caffeine-enriched aqueous extraction liquid, has an elevated concentration of adsorbed caffeine, i.e. caffeine bound by adsorption. In step (S3), caffeine is leached from the laden adsorber resin into dichloromethane; this reduces the loading of the adsorber resin with caffeine.

In order to overcome the disadvantages of processes known from the prior art for production of decaffeinated green coffee beans, as set out above, and to provide a particularly efficient process for producing decaffeinated green coffee beans, the inventors have considered a multitude of factors and conducted studies. In so doing, the inventors have been faced by various challenges and had to overcome prejudices from the prior art.

In the course of developing the invention, the inventors decided that the green coffee beans should not be brought into direct contact with organic solvents such as dichloromethane (DCM), or at least not to a relevant degree. At the same time, however, they wanted to utilize the solubility of caffeine in dichloromethane in an advantageous manner.

In an effort to avoid the above-described disadvantages of liquid-liquid extraction of caffeine from an aqueous extraction liquid with DCM, the inventors used a suitable adsorber resin as a kind of “intermediate caffeine storage medium”, and developed, in short, a novel and technically advantageous two-stage extraction sequence of “liquid-solid” (aqueous extract/adsorber resin) plus “solid-liquid” (laden adsorber resin/DCM) for removal and recovery of caffeine from an aqueous extraction liquid. This two-stage extraction sequence corresponds to steps (S2) and (S3) of the process of the invention.

It has been found that, surprisingly,
i) adsorber resins in step (S2) of the invention can not only bind caffeine from a caffeine-enriched aqueous extraction liquid,

but also
ii) can (selectively) release caffeine to dichloromethane in step S3 of the invention.

The invention makes particular use of the technical fact that caffeine has good solubility both in warm water and in dichloromethane (by contrast with other polar constituents of the green coffee). In the process of the invention, there is no direct contact of the green coffee beans themselves or of an aqueous, caffeine-enriched extraction solution with dichloromethane. In this way, contamination of the aqueous extraction liquid with dichloromethane is completely or at least largely avoided. This is a particularly crucial aspect of the present invention, especially with regard to the above-described disadvantages of organic solvent residues in coffee products.

The above-defined step S3 envisaged in accordance with the invention, especially the desorption of caffeine bound to adsorber resin by means of dichloromethane, additionally has the effect that the adsorber resin is freed of caffeine or unladen and hence can be reused in a step S2. The adsorber resin can thus be reused (and repeatedly) to (selectively) bind caffeine from an aqueous extraction liquid and then to release it (selectively) to dichloromethane.

It is advantageous that, after the selective desorption of caffeine bound to the adsorber resin by means of dichloromethane in step S3, individual or multiple, preferably multiple, more preferably all, noncaffeine coffee constituents that are present in the caffeine-enriched aqueous extraction liquid resulting from step S1 remain essentially bound to the adsorber resin. After step S3, the adsorber resin has then been preladen with individual or multiple noncaffeine coffee constituents, where these coffee constituents are preferably selected from the group consisting of acids, minerals, aromas, compounds convertible to aromas by Maillard reaction, and antioxidants. Therefore, the adsorber resin thus preladen, when reused (repeatedly) in a/another step S2, has elevated selectivity for the adsorption of caffeine from the caffeine-enriched aqueous extraction liquid.

Preference is given to a process of the invention (as described above, preferably as identified above as preferred), wherein the contacting of the caffeine-laden adsorber resin that arises in step S2 with dichloromethane in step S3 is effected in such a way that 50% by weight or more, preferably 60% by weight or more, preferably 70% by weight or more, preferably 80% by weight or more, preferably 90% by weight or more, preferably 95% by weight or more, preferably 99% by weight or more, of the caffeine bound to the adsorber resin in step S2 is dissolved in the dichloromethane. The figures in percent by weight (% by weight) are based here in each case on the total mass of the caffeine bound to the adsorber resin in step S2. For this purpose, the person skilled in the art selects suitable durations and temperatures for step S3.

After contacting with dichloromethane in step S3, the noncaffeine coffee constituents present in the caffeine-enriched aqueous extraction liquid that arises in step S1 preferably remain bound to the adsorber resin in such a large amount that the same coffee constituents, in the case of (repeated) reuse of the adsorber resin resulting from step S3 in a process of the invention, are bound to the adsorber resin in step S2 only in an amount of 15% by weight or less, preferably 10% by weight or less, preferably 5% by weight or less, preferably 1% by weight or less. The figures in percent by weight (% by weight) are based in each case on the total amount of these noncaffeine coffee constituents in the caffeine-enriched aqueous extraction liquid that arises in step S1. For this purpose, the person skilled in the art selects suitable durations and temperatures for step S3.

The proportion of caffeine in the mixture of all solids that bind to the adsorber resin in step S2 is preferably 40% by weight or more, preferably 50% by weight or more, preferably 60% by weight or more, preferably 70% by weight or more, preferably 80% by weight or more, preferably 90% by weight or more, preferably 99% by weight or more. The figures in percent by weight (% by weight) are based in each case on the total mass of all solids adsorbing on the adsorber resin in step S2.

The proportion of the noncaffeine coffee constituents present in the caffeine-enriched aqueous extraction liquid that arises in step S1 in the mixture of all solids that are adsorbed on the adsorber resin in step S2 is preferably 60% by weight or less, preferably 50% by weight or less, preferably 40% by weight or less, preferably 30% by weight or less, preferably 20% by weight or less, preferably 10% by weight or less, preferably 1% by weight or less. The figures in percent by weight (% by weight) are based in each case on the total mass of all solids adsorbing on the adsorber resin in step S2.

It is advantageous that the adsorber resin that results after step S3 is enriched in noncaffeine coffee constituents. The adsorber resin preladen in this way has elevated adsorption selectivity for caffeine compared to an adsorber resin that has not yet undergone steps S2 and S3. The use of a correspondingly preladen adsorber resin makes it possible to remove caffeine with particularly high selectivity from the caffeine-enriched aqueous extraction liquid that arises in step S1.

The aqueous extraction liquid is preferably recycled after step S2. It is thus preferably used for another (repeated) extraction of caffeine from green coffee beans. Because the aqueous extraction liquid after step S1 contains caffeine and further coffee constituents, and because this aqueous extraction liquid is able to release a large amount of caffeine but only small amounts of the further (noncaffeine) coffee constituents to the adsorber resin when contacted with a preladen adsorber resin, comparatively small amounts of the further coffee constituents are extracted from the green coffee beans on the renewed use of the aqueous extraction liquid present after step S2 in a (new) step S1. This is particularly advantageous. An advantageous process of the invention is therefore one in which an aqueous extraction liquid that arises in a step S2 from a preceding run of steps S1 and S2 of the process and comprises individual or multiple noncaffeine coffee constituents is used in step S1.

The process of the invention enables production of high-quality decaffeinated green coffee beans using (repeatedly) recycled aqueous extraction liquid. The caffeine content of the green coffee beans is distinctly reduced by the process of the invention. The coffee constituents that are particularly important for the flavor and the aroma of the coffee remain in the decaffeinated green coffee beans; contamination of the decaffeinated green coffee beans with dichloromethane can be avoided even in the case of recycling of the aqueous extraction liquid.

It is advantageous that the caffeine-enriched dichloromethane solution that results after step S3 has a high concentration of caffeine and simultaneously a low concentration of other coffee constituents. This is because dichloromethane is unable to dissolve any polar coffee constituents that have been extracted from the aqueous extraction liquid and bound by the adsorber resin in a relevant amount. This is important especially because caffeine and caffeine extracts are also important materials of value and valuable commercial products (for example as a food and drink additive or for pharmaceutical products). The process of the invention is thus particularly economically viable since, in a manner which is efficiently implementable from a process engineering point of view, not just one but two high-quality and valuable products are (can be) produced, namely decaffeinated green coffee beans (first product) and caffeine or caffeine extract (second product).

The process of the invention is preferably a continuous or semicontinuous or a periodically performed process, wherein one or more components are recycled (recirculated) and/or reused.

Preferably, in the process of the invention, step S1 and/or step S2 and/or step S3 is performed repeatedly, where the adsorber resin is preferably exchanged only after repeated performance of said step(s). In the case of repeated performance of step S1, preferably multiple batches of respectively fresh caffeinated green coffee beans are contacted with an aqueous extraction liquid, such that caffeine is extracted each time from the caffeinated green coffee beans into the extraction liquid.

Preferably, in the process of the invention, step S1 and/or step S2 and/or step S3 is performed at least twice, preferably at least three times, preferably at least four times, preferably more than four times. In this respect too, the adsorber resin is exchanged only after the repeated (second, third, fourth or more than fourth) performance of said step(s).

Preferably, in the process of the invention, all steps S1, S2 and S3 are each performed repeatedly (at least twice) in succession.

Preferably, in the process of the invention, all steps S1, S2 and S3 are performed at least twice, preferably at least three times, preferably at least four times, preferably more than four times, in each case in succession.

In the case of repeated performance (at least twice) of steps S1 and S2, preferably of steps S1 and S2 and S3, in the process of the invention, the aqueous extraction liquid after performance of step S2 or a processing product of the aqueous extraction liquid is preferably recycled (recirculated) once or more than once, preferably repeatedly (at least twice), and is used as the aqueous extraction liquid for extraction of caffeine from caffeinated green coffee beans in another performance of step S1 (preferably with a fresh batch of caffeinated green coffee beans). By virtue of the repeated performance (at least twice) of step S2, a comparatively large amount of caffeine and a comparatively small amount of noncaffeine coffee constituents is removed from the, preferably recycled, extraction liquid that arises in step S1 and bound to the (preladen) adsorber resin. A comparatively large amount of the noncaffeine coffee constituents thus remains in the aqueous extraction liquid and is recycled therewith; the extraction liquid thus enriched with noncaffeine coffee constituents consequently has reduced uptake capacity for noncaffeine coffee constituents (compared to an aqueous extraction liquid that does not contain such coffee constituents) when contacted with green coffee beans in a new step S1. The selectivity of the recycled extraction liquid for the extraction of caffeine is preferably elevated because of the presence of noncaffeine coffee constituents (this is generally true of all aspects of the present invention). By virtue of the preferably repeated recycling (at least twice) of the aqueous extraction liquid after performance of step S2 or a processing product thereof, therefore, in each new performance of step S1, a comparatively large amount of caffeine is selectively extracted from the caffeinated green coffee beans into the extraction liquid together with a comparatively small amount of further noncaffeine coffee constituents. Preferably, in the case of repeated performance (at least twice) of step S1, no additional amounts of noncaffeine coffee constituents are extracted from the caffeinated green coffee beans into the extraction liquid.

In the case of repeated performance (at least twice) of step S1, preferably of steps S1 and S2, more preferably of steps S1 and S2 and S3, in the process of the invention, the green coffee beans are preferably replaced or supplemented with respectively fresh caffeinated green coffee beans after each performance of step S1 (batchwise operation). In each new performance of step S1, caffeine is thus extracted from caffeinated green coffee beans with an aqueous, preferably recycled, particularly preferably repeatedly recycled (at least twice), extraction liquid from the caffeinated green coffee beans into the extraction liquid.

In the case of repeated performance (at least twice) of steps S2 and S3, preferably of steps S1 and S2 and S3, in the process of the invention, the adsorber resin is preferably reused once or more than once, preferably repeatedly (at least twice), after performance of step S3. Even after the first performance of steps S1, S2 and S3, the adsorber resin has been preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-containing extraction liquid that arises in step S1 to the adsorber resin. In other words: the selectivity of the adsorber resin for the adsorption of caffeine is preferably elevated owing to preloading with adsorbed noncaffeine coffee constituents by comparison with the non-preladen adsorber resin (this is generally applicable to all aspects of the present invention).

By virtue of the preferably repeated reuse (at least twice) of the adsorber resin after step S3, caffeine is therefore bound to the adsorber resin with comparatively high selectivity from the caffeine-containing extraction liquid that arises in step S1. By virtue of the preferably repeated reuse (at least twice) of the adsorber resin after step S3, even in the second performance of step S2 and every further performance of step S2, a comparatively large amount of caffeine is thus bound from the aqueous extraction liquid onto the adsorber resin together with a comparatively small amount of further noncaffeine coffee constituents.

Preferably, in the case of repeated performance (at least twice) of step S2 with reuse of the adsorber resin after the respectively subsequent step S3, no additional amounts of noncaffeine coffee constituents are bound from the aqueous extraction liquid onto the adsorber resin.

A particularly preferred process of the invention is a process for producing decaffeinated green coffee beans, having the following steps:
(S1) contacting an amount of caffeinated green coffee beans with an aqueous extraction liquid so as to extract caffeine from the caffeinated green coffee beans into the extraction liquid,
(S2) contacting the caffeine-enriched aqueous extraction liquid that arises in step S1 with an adsorber resin so as to bind caffeine from the extraction liquid to the adsorber resin,
(S3) contacting the caffeine-laden adsorber resin that arises in step S2 with dichloromethane so as to dissolve caffeine in the dichloromethane,
wherein steps S1, S2 and S3 are each performed repeatedly (at least twice), preferably at least three times, preferably at least four times, preferably more than four times, in each case in succession, and the green coffee beans are preferably replaced or supplemented with fresh caffeinated green coffee beans in step 1 after each performance of step S1
and/or
wherein the aqueous extraction liquid that arises in step S2 or a processing product of that extraction liquid is recycled and used as aqueous extraction liquid in a new performance of step S1
and/or
wherein the adsorber resin is preferably reused after performance of step S3.

Preferably, in the process of the invention, the aqueous extraction liquid that arises in step S2 or a processing product of that extraction liquid is recycled repeatedly (at least twice), preferably at least three times, preferably at least four times, preferably more than four times, and used as aqueous extraction liquid in a new performance of step S1.

Preferably, in the process of the invention, the adsorber resin is reused repeatedly (at least twice) after performance of step S3, preferably at least three times, preferably at least four times, preferably more than four times.

In summary, the inventors have succeeded in combining relevant benefits of known decaffeination methods without having to accept the respective drawbacks that exist for the individual methods.

Preference is given to a process of the invention (as described above, preferably as identified above as preferred), wherein an adsorber resin used in step S2 has been preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-containing extraction liquid that arises in step S1 to the adsorber resin.

It has been found that step (S2) is particularly efficient when an adsorber resin that has been preladen with individual or multiple aforementioned coffee constituents is used here.

When such an adsorber resin preladen with individual or multiple aforementioned coffee constituents is used, in step S2, the binding (adsorption) of corresponding coffee constituents (other than caffeine) from the caffeine-containing aqueous extraction liquid that arises in step S1 to the adsorber resin is prevented or at least made much more difficult. These coffee constituents thus remain (at least essentially) in the aqueous extraction liquid and are preferably used again therewith in a step S1. Caffeine, by contrast, is bound by the adsorber resin in step S2.

Particular preference is given to a process of the invention in which
i) step S1 comprises using an aqueous solution comprising individual or multiple noncaffeine coffee constituents selected from the group consisting of acids, minerals, aromas, compound convertible to aromas by Maillard reaction, and antioxidants,
and
ii) step S2 comprises using an adsorber resin that has been preladen with individual or multiple noncaffeine coffee constituents selected from the group consisting of acids, minerals, aromas, compound convertible to aromas by Maillard reaction, and antioxidants.

This particularly preferred configuration has the effect that:
i) step S1 (selectively) extracts caffeine from the caffeinated green coffee beans into the aqueous extraction liquid, while other water-soluble coffee constituents that are particularly important for the taste and the aroma of the coffee are extracted only to a small degree, if at all, and hence remain in the decaffeinated green coffee beans
and
ii) step S2 (selectively) binds or adsorbs caffeine onto the preladen adsorber resin, while other water-soluble coffee constituents that are particularly important for the taste and the aroma of the coffee are adsorbed only to a small degree, if at all, and hence remain in the aqueous extraction solution.

Particular preference is given to a process of the invention, having the following additional step:
(pre-S2) producing or providing an adsorber resin that has been preladen with individual or multiple noncaffeine coffee constituents selected from the group consisting of acids, minerals, aromas, compound convertible to aromas by Maillard reaction, and antioxidants.

Step (pre-S2) preferably comprises one or more of the following measures:
producing or providing an aqueous solution comprising individual or multiple noncaffeine coffee constituents selected from the group consisting of acids, minerals, aromas, compound convertible to aromas by Maillard reaction, and antioxidants; the aqueous solution produced or provided here does not preferably comprise any caffeine or comprises less than 300 mg of caffeine per liter of aqueous solution, preferably less than 100 mg of caffeine per liter of aqueous solution;
producing or providing an adsorber resin;
contacting the aqueous solution produced or provided, comprising individual or multiple noncaffeine coffee constituents selected from the group consisting of acids, minerals, aromas, compound convertible to aromas by Maillard reaction, and antioxidants with the adsorber resin produced or provided so as to result in an adsorber resin preladen with individual or multiple noncaffeine coffee constituents selected from the group consisting of acids, minerals, aromas, compounds convertible to aromas by Maillard reaction, and antioxidants.

Particular preference is given to the use of a preladen adsorber resin that has been saturated with individual or multiple noncaffeine coffee constituents selected from the group consisting of acids, minerals, aromas, compound convertible to aromas by Maillard reaction, and antioxidants. What is meant here by saturation is that the preladen saturated adsorber resin is unable to bind any more of the substances mentioned. Preference is given to a process of the invention (as described above, preferably as identified above as preferred), wherein the aqueous extraction liquid used in step S1 is
water

or
an aqueous solution comprising individual or multiple noncaffeine coffee constituents selected from the group consisting of acids, minerals, aromas, compounds convertible to aromas by Maillard reaction, and antioxidants, so as to hinder or prevent extraction of corresponding coffee constituents from the caffeinated green coffee beans into the extraction liquid.

In the context of the present invention, (water-soluble) aromas present in the aqueous solution and/or the compounds convertible to aromas by Maillard reaction are preferably selected from the group consisting of chlorogenic acids, amino acids, sugars and water-soluble peptides.

In a particularly preferred process of the invention, step S1 comprises contacting an amount of caffeinated green coffee beans with an aqueous extraction liquid, where the aqueous extraction liquid used is an aqueous solution comprising individual or multiple noncaffeine coffee constituents selected from the group consisting of acids, minerals, aromas, compound convertible to aromas by Maillard reaction, and antioxidants. The effect of the use of such an aqueous solution containing coffee constituents is that the extraction of the corresponding substances from the caffeinated green coffee beans into the aqueous solution is prevented or at least made much more difficult. The green coffee beans are thus selectively extracted, such that caffeine is transferred to the aqueous extraction liquid, but other coffee constituents are transferred only to a minor degree, if at all.

The aqueous solution used in step S1 has preferably been saturated with one or more of the abovementioned coffee constituents.

The effect of the preferred use of such an aqueous extraction solution that comprises individual or multiple coffee constituents, and preferably of an aqueous extraction solution that has been saturated with one or more coffee constituents is that valuable water-soluble coffee constituents (in particular those that are sensorily valuable) remain in the green coffee beans in the extraction in step S1 of the process of the invention and are not transferred into the extraction liquid. This results in particularly high quality of the resulting decaffeinated green coffee beans.

The process of the invention can be performed continuously, semicontinuously or discontinuously (as a batchwise process). For industrial purposes, preference is given to a continuous or semicontinuous process regime in which at least portions of the process are performed over a prolonged period without interruption.

In a process of the invention, process step S1 is preferably conducted semicontinuously.

Particular preference is given to performing process step S1 semicontinuously by (i) circulating the aqueous extraction liquid and repeatedly contacting it with the green coffee beans (ii) or contacting the aqueous extraction liquid with the green coffee beans, leaving them in contact for a period of time and only then pouring them over the adsorber resin. In a semicontinuous process, the composition of the aqueous extraction liquid used may vary to a certain degree. For example, the extraction liquid used in step S1 at the start of the process may be pure water and, in the case of repeated performance of step S1 within a semicontinuous process, can be converted to an aqueous solution comprising individual or multiple coffee constituents (especially the aforementioned noncaffeine coffee constituents). As the process progresses, the concentration of the individual or multiple above-specified coffee constituents in the aqueous extraction solution rises.

Preferably, the caffeine content in the aqueous extraction liquid used in step S1 is less than 300 mg per liter of aqueous extraction liquid, more preferably less than 100 mg per liter.

Particular preference is given to a process of the invention, wherein the aqueous extraction liquid used in step S1 is an aqueous solution comprising individual or multiple noncaffeine coffee constituents selected from the group consisting of acids, minerals, aromas, compound convertible to aromas by Maillard reaction, and antioxidants, wherein the aqueous extraction liquid is produced prior to commencement of step S1. The production of such an aqueous extraction liquid can be produced by the person skilled in the art with water, especially by mixing known water-soluble (above-described) (noncaffeine) coffee constituents; but it is also possible to use aqueous extraction liquid that has been produced in a process of the invention or other process conducted beforehand by extraction of green coffee beans and processing of the liquid aqueous extract.

In a particularly preferred configuration of the process of the invention, the aqueous solution used in step S1 is thus an aqueous extraction liquid resulting from a process of the invention performed beforehand, preferably an aqueous extraction liquid having a caffeine content of less than 300 mg per liter of aqueous extraction liquid, more preferably less than 100 mg per liter, most preferably an aqueous extraction liquid excluding caffeine.

Preference is given to a process of the invention (as described above, preferably as identified above as preferred) wherein, in step S2,
a macroporous adsorber resin selected from the group consisting of polystyrene, polydivinylbenzene and copolymers thereof with one another and with other monomers is used,
   wherein the macroporous adsorber resin is preferably a polystyrene or a copolymer of polystyrene, preferably a crosslinked polystyrene, more preferably a divinylbenzene-crosslinked polystyrene, most preferably a non-functionalized, nonionic and divinylbenzene-crosslinked polystyrene,

and/or (preferably “and”)
at least 90%, preferably at least 95%, most preferably at least 99%, of the caffeine from the caffeine-containing extraction liquid is bound to the adsorber resin.

In the course of in-house experimental studies, it has been found that the adsorber resin used in step S2 is preferably a macroporous adsorber resin, preferably having an average pore diameter of greater than 5 nm. When a macroporous adsorber resin is used, both the adsorption of caffeine from the caffeinated aqueous extraction solution and the desorption of caffeine by means of DCM are effected particularly efficiently.

The macroporous adsorber resin here is selected from the group consisting of polystyrene, polydivinylbenzene and copolymers thereof with one another and with other monomers. It is a particular feature of polystyrene, polydivinylbenzene and copolymers thereof with one another and with other monomers that they have good solvent compatibility, both with respect to aqueous extraction liquids and with respect to DCM. In addition, it is a feature of the aforementioned polymer materials that they are thermally stable over a broad temperature range up to 150° C.

In experimental studies, it has additionally been found that polystyrenes or copolymers of polystyrene are very long-lived and stable in the course of the process of the invention, especially in the course of process steps S2 and S3. These materials may thus be used repeatedly and barely lose their advantageous properties even through repeated performance of process steps S2 and S3.

The macroporous adsorber resin used with preference in step S2 is preferably a polystyrene or a copolymer of polystyrene, more preferably a crosslinked polystyrene, more preferably a divinylbenzene-crosslinked polystyrene, most preferably a non-functionalized, nonionic and divinylbenzene-crosslinked polystyrene. In in-house studies (cf. the examples further down), it has been found that these adsorber resins are of particularly good suitability for use in the process of the invention described here for production of decaffeinated green coffee beans.

The process of the invention is of course not limited to the preferred adsorber resins cited here. The inventors have merely found that these preferred adsorber resins mentioned here are particularly suitable for binding of caffeine from an aqueous extraction solution and then of releasing it or desorbing it again when contacted with dichloromethane. It can be assumed that other adsorber resins known from the prior art are likewise suitable for this purpose. The person skilled in the art is able to find out by suitable preliminary experiments whether other adsorber resins are suitable for use in a process of the invention. For this purpose, it is necessary in particular to take account of the adsorption affinity of the material in question with respect to caffeine and the desorption properties of bound caffeine on contact with DCM.

Preference is given to a step S2 of the invention in which at least 90%, preferably at least 95%, most preferably at least 99%, of the caffeine from the caffeine-containing extraction liquid is bound to the adsorber resin (so-called caffeine adsorption values). The amount of caffeine that is bound to the adsorber resin from the caffeine-containing extraction liquid can be determined by customary analysis methods. A particular option for this purpose is to measure the caffeine content of the caffeine-containing extraction liquid prior to contacting with the adsorber resin and to determine it again after contacting with the adsorber resin. In order to attain the preferred caffeine adsorption values, the person skilled in the art will in particular use a suitable adsorber resin in a suitable amount. The person skilled in the art will more preferably use a macroporous adsorber resin as described above. The person skilled in the art will also vary the process parameters in a customary manner and here in particular adjust temperature, pressure and contacting time of the aqueous extraction liquid with the adsorber resin in a controlled manner. The person skilled in the art, in the case of a relatively large amount of green coffee beans, will of course also provide a greater amount of suitable adsorber resin.

Preference is given to a process of the invention (as described above, preferably as identified above as preferred) wherein, in step S3,
the contacting is performed in such a way that at least 80%, preferably at least 90%, more preferably at least 95%, most preferably at least 99%, of the caffeine from the caffeine-laden adsorber resin is dissolved in the dichloromethane,

and/or
the temperature of the dichloromethane is lower than 35° C., preferably lower than 30° C., more preferably lower than 25° C.

It has been found to be particularly advantageous that, in step S3, the contacting is performed in such a way that at least 80%, preferably at least 90%, more preferably at least 95%, most preferably at least 99%, of the caffeine from the caffeine-laden adsorber resin is dissolved in the dichloromethane. The person skilled in the art is aware of analysis methods suitable for determining the concentration values of caffeine in dichloromethane that are cited here. The aforementioned values are established by the person skilled in the art in a customary manner by choosing suitable process parameters; these especially include the temperature, the pressure, the contacting time and the amount of dichloromethane which is contacted with the caffeine-laden adsorber resin.

It has been found that, surprisingly, the macroporous adsorber resin used with preference in step S2, selected from the group consisting of polystyrene, polydivinylbenzene and copolymers thereof with one another and with other monomers, is particularly readily suitable for selective release of the previously adsorbed caffeine to dichloromethane in step S3 on contact with the dichloromethane.

The temperature of the dichloromethane in step S3 is variable in a wide range. But it has been found that good caffeine desorption is regularly achieved even below 35° C. There is therefore no need to heat the dichloromethane and to work under elevated pressure. It is thus possible in a process of the invention to work with dichloromethane or with a dichloromethane solution at a comparatively low temperature. A low temperature of the dichloromethane is technically advantageous especially because dichloromethane has a low boiling point of only 39.8° C. and is thus readily volatile.

Preference is given to a process of the invention (as described above, preferably as identified above as preferred), wherein step S1 is performed in such a way that at least a predetermined amount of caffeine is extracted from the amount of caffeinated green coffee beans.

In the inventive decaffeination of green coffee beans, target values for the caffeine concentration in the decaffeinated green coffee beans to be produced are preferably fixed. In a preferred process of the invention, the person skilled in the art is thus able to determine, prior to performance of the process of the invention, what amount of caffeine should be extracted from the amount of caffeinated green coffee beans. For example, they are thus able to stipulate that the natural caffeine content of 1.2%, for example, in the caffeinated green coffee beans at the start of step S1 should be reduced to a value of not more than 0.1% after performance of step S1. They can then perform step S1 of the invention such that the target value that they have selected is attained. For this purpose, they can especially perform step S1 repeatedly in a semicontinuous process such that the green coffee beans are contacted repeatedly with an aqueous extraction liquid, the effect of which is that at least the above-defined, i.e. predetermined, amount of caffeine is extracted from the caffeinated green coffee beans into the extraction liquid.

Preference is given to a process of the invention (as described above, preferably as identified above as preferred), wherein the decaffeinated green coffee beans that arise in step S1 are dried.

The drying of decaffeinated green coffee beans is a widespread process step in the production of decaffeinated coffee. Since the green coffee beans are not directly contacted with an organic solvent such as DCM in step S1, the dried decaffeinated green coffee beans do not contain any organic solvents, or only very small amounts of organic solvents. It is thus possible to directly sell the dried decaffeinated green coffee beans without further measures.

Preference is given to a process of the invention (as described above, preferably as identified above as preferred) comprising the additional step after step S3:
(S4) treating the adsorber resin
   (S4-1) to remove dichloromethane
   and/or (preferably “and”)
   (S4-2) to regenerate the loadability of the adsorber resin with caffeine under the conditions of step S2.

In step S3 of the process of the invention, the caffeine-laden adsorber resin that arises in step S2 is contacted with dichloromethane so as to dissolve caffeine in the dichloromethane. One effect of this step S3 is that caffeine is leached from caffeine-laden adsorber resin, but also another is that the adsorber resin is then surrounded by dichloromethane. In order that the adsorber resin used in step S3, after performance of step S3, can be reused in a step S2 of a preferably semicontinuously implemented process of the invention, dichloromethane is removed from the adsorber resin, preferably removed completely. There is thus avoidance of direct contact of the aqueous extraction liquid with dichloromethane.

The treating of the adsorber resin for (preferably complete) removal of dichloromethane in step S4-1 preferably comprises one or more of the following measures:
treating the adsorber resin with liquid water or an aqueous solution, preferably at a water temperature of at least 70° C., more preferably of at least 85° C., so as to remove DCM from the adsorber resin, preferably from pores of the adsorber resin,
treating the adsorber resin with steam, so as to remove DCM from the adsorber resin, preferably from pores of the adsorber resin.

Additional measures customary in the art, or the repetition of measures, are advantageous in some cases in order to very substantially remove the dichloromethane from the adsorber resin.

It is particularly advantageous when the process of the invention comprises the additional process step S4-2, where this step S4-2 is effected for regeneration of the loadability of the adsorber resin with caffeine under the conditions of step S2. After step S4-2, the adsorber resin should thus be prepared for a new loading operation under the conditions of a step

S2, and hence should have (at least nearly) regained the former loadability with caffeine. Step S4-2 preferably comprises the following measure:
treating the adsorber resin with an aqueous alkaline solution, preferably a sodium hydroxide-containing aqueous solution, preferably at a temperature in the range from 60° C. to 80° C.

In in-house studies, it has been found that it is advantageous to regenerate the adsorber resin used in order thus to restore or to improve the loadability of the adsorber resin with caffeine under the conditions of step S2. This process step S4-2 is performed especially when it is found that the adsorption or desorption property of the adsorber resin worsens with time. Step S4-2 is preferably effected at fixed predetermined time intervals, or intervals that depend on the performance of the adsorber resin. The use of an aqueous alkaline solution, preferably a sodium hydroxide-containing aqueous solution, preferably at a temperature in the range from 60° C. to 80° C., has been found to be useful in in-house studies, especially in the case of use of the (for example preladen and/or macroporous) adsorber resins that are identified above as preferred.

Preference is given to a process of the invention (as described above, preferably as identified above as preferred), wherein
the contacting in step S2 comprises flow of the caffeine-enriched aqueous extraction liquid that arises in step S1 over the adsorber resin
and/or (preferably “and”)
the subsequent contacting in step S3 comprises flow of dichloromethane over the caffeine-laden adsorber resin.

In this case, the contacting in step S2 preferably comprises flow of the caffeine-enriched aqueous extraction liquid that arises in step S1 over the adsorber resin in a defined first flow direction, and the subsequent contacting in step S3 comprises flow of dichloromethane over the caffeine-laden adsorber resin in a defined second flow direction. It is frequently advantageous when the second flow direction is the opposite direction from the first flow direction; in other cases (especially depending on the geometry of the adsorption unit), the first and second flow directions are the same.

Preferably, both the contacting in step S2 and the subsequent contacting in step S3 are effected by respective flow over the adsorber resin or the caffeine-laden adsorber resin, namely in step S2 by the caffeine-enriched aqueous extraction liquid that arises in step S1, or in step S3 by dichloromethane.

The expression “flowing over” in the present text means the passage of a solution in a particular flow direction over the adsorber resin or over the caffeine-laden adsorber resin. It has been found that both the binding (adsorption) of caffeine to the adsorber resin and the leaching (desorption) of caffeine from the laden adsorber resin are effected particularly efficiently when the respective liquid flows over the adsorber resin or the laden adsorber resin.

In many cases, the contacting in step S2 is effected by flow of the caffeine-enriched aqueous extraction liquid that arises in step S1 over the adsorber resin in a (first) defined flow direction, while in step S3 the subsequent contacting of the caffeine-laden adsorber resin with dichloromethane is effected in the opposite direction thereto. This means, for example, in the case of a vertically mounted adsorber column filled with adsorber resin, that the contacting in step S2 (flow of the caffeine-enriched aqueous extraction liquid that arises in step S1 over the adsorber resin) is effected from the top downward, for example, while the subsequent contacting in step S3 (the flow of dichloromethane over the caffeine-laden adsorber resin) is effected in the opposite direction, i.e. from the bottom upward.

This “countercurrent method” frequently contributes in particular to particularly efficient (selective) desorption of caffeine, i.e. the leaching of caffeine adsorbed on the adsorber resin into dichloromethane in step S3.

Preferably, in the case of performance of the contacting in step S2 by means of flow of the caffeine-enriched aqueous extraction liquid that arises in step S1 over the adsorber resin, at least 90%, preferably at least 95%, most preferably at least 99%, of the caffeine is bound to the adsorber resin from the caffeine-containing extraction liquid.

Preferably, in the case of performance of the contacting in step S3 by flow of dichloromethane over the caffeine-laden adsorber resin, at least 80%, preferably at least 90%, more preferably at least 95%, most preferably at least 99%, of the caffeine is leached out of the caffeine-laden adsorber resin into the dichloromethane.

Preference is given to a process of the invention (as described above, preferably as identified above as preferred), wherein the progress attained in the extraction in step S1 and/or the loading of the adsorber resin with caffeine attained in step S2 is determined and the process moves from step S2 to step S3, preferably by automatic switchover, as soon as a predetermined progression of the extraction in step S1 has been attained and/or as soon as a predetermined loading of the adsorber resin with caffeine in step S2 has been attained.

The progress achieved in the extraction in step S1 can be determined by measures customary in the art. For example, it is possible to determine the progress achieved in the extraction in step S1 from the difference between caffeine present in the green coffee beans at commencement of step S1 and the caffeine already extracted into the aqueous extraction solution at a particular time or the caffeine already bound to the adsorber resin. Alternatively, the progress achieved in the extraction in step S1 can be determined from the progression of the caffeine concentration in the aqueous extraction liquid that has been contacted with the green coffee beans against time.

The loading of the adsorber resin with caffeine which is achieved in step S2 can likewise be determined directly or indirectly by methods customary in the art. For example, in the course of an indirect determination, it is possible to determine the concentration of caffeine in the aqueous extraction solution prior to step S2, i.e. prior to the contacting with the adsorber resin, and after step S2, i.e. after the contacting with the adsorber resin, in order to thus establish whether caffeine is still bound to the adsorber resin. If no further caffeine (or only little) is being adsorbed, the loading is complete (or far advanced).

In the preferred embodiment of the process of the invention discussed, the process moves from step S2 to step S3, preferably by automatic switchover, as soon as a predetermined progression of the extraction in step S1 (as described above) has been attained and/or (preferably “and”) as soon as a predetermined loading of the adsorber resin with caffeine in step S2 has been attained (as described above).

In other words, the process preferably then moves from step S2 (loading of the adsorber resin with caffeine) to step S3 (unloading of caffeine from the adsorber resin) as soon as a predetermined amount of caffeine has been extracted from the green coffee beans and/or a predetermined amount of caffeine has been bound to the adsorber resin. In such a preferred process, the process switches in an efficient and technically advantageous manner between the “liquid-solid” (aqueous extract/adsorber resin) extraction and the “solid-liquid” (laden adsorber resin/DCM) extraction.

The effect of the preferred transition from step S2 to S3 described is that, on attainment of the caffeine loading limit of the adsorber resin, the caffeine present in the aqueous extraction liquid is not recycled and contacted with green coffee beans. Instead, as a result of transition to step S3, bound caffeine is leached from the adsorber resin, such that the resulting adsorber resin (freed of caffeine) is available again for use in a step S2.

Preference is given to a process of the invention (as described above, preferably as identified above as preferred), wherein aqueous extraction liquid is circulated once or more than once, preferably with reuse of the caffeine-depleted aqueous extraction liquid that arises in step S2 or a processing product thereof as aqueous extraction liquid in step S1.

It is especially preferred in this respect when the aqueous extraction liquid that has been circulated once or more than once, at least after its first cycle, comprises individual or multiple noncaffeine coffee constituents selected from the group consisting of acids, minerals, aromas, compound convertible to aromas by Maillard reaction, and antioxidants.

By virtue of the preferred single or repeated recycling of the aqueous extraction liquid (“recycling” here refers to single or repeated conveying in circulation), the property of the adsorber resin as a kind of “intermediate caffeine storage medium” is exploited in a particularly advantageous manner, namely by exploiting the ability of the adsorber resin to repeatedly bind caffeine from the aqueous extraction liquid. What is particularly exploited here is the fact that the adsorber resin has a high affinity for caffeine so as to bind caffeine (selectively) to the adsorber resin from the aqueous extraction liquid in step S2. It has been found that the adsorption of caffeine on the adsorber resin is also particularly efficient, especially in a semicontinuous process.

Since the aqueous extraction liquid has been depleted of caffeine after being contacted with the adsorber resin in step S2, preferably comprising less than 300 mg of caffeine per liter of aqueous solution, more preferably less than 100 mg of caffeine per liter of aqueous solution, most preferably no caffeine, this caffeine-depleted aqueous extraction liquid is suitable for reuse as aqueous extraction liquid in step S1. The caffeine-depleted aqueous extraction liquid that is to be reused as aqueous extraction liquid preferably contains individual or multiple noncaffeine coffee constituents selected from the group consisting of acids, minerals, aromas, compounds convertible to aromas by Maillard reaction, and antioxidants, so as to hinder or prevent extraction of corresponding coffee constituents from the caffeinated green coffee beans into the extraction liquid. These noncaffeine coffee constituents are thus preferably not fully adsorbed, if at all, by the adsorber resin, preferably because the adsorber resin has already been laden with these coffee constituents in a preceding step. With regard to these aspects, see also the individual details further up.

Preference is given to a process of the invention (as described above, preferably as identified above as preferred) comprising the following steps:
(S1) contacting an amount of caffeinated green coffee beans with an aqueous extraction liquid so as to extract caffeine from the caffeinated green coffee beans into the extraction liquid,
wherein the aqueous extraction liquid used in step S1 is
   water
or
   an aqueous solution comprising individual or multiple noncaffeine coffee constituents selected from the group consisting of acids, minerals, aromas, compounds convertible to aromas by Maillard reaction, and antioxidants, so as to hinder or prevent extraction of corresponding coffee constituents from the caffeinated green coffee beans into the extraction liquid,
(S2) contacting the caffeine-enriched aqueous extraction liquid that arises in step S1 with an adsorber resin so as to bind caffeine from the extraction liquid to the adsorber resin,
wherein an adsorber resin used in step S2 has been
preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-containing extraction liquid that arises in step S1 to the adsorber resin,
and wherein, in step S2,
   a macroporous adsorber resin selected from the group consisting of polystyrene, polydivinylbenzene and copolymers thereof with one another and with other monomers is used,
wherein the macroporous adsorber resin is preferably a polystyrene or a copolymer of polystyrene, preferably a crosslinked polystyrene, more preferably a divinylbenzene-crosslinked polystyrene, most preferably a non-functionalized, nonionic and divinylbenzene-crosslinked polystyrene,
and/or (preferably “and”)
   at least 90%, preferably at least 95%, most preferably at least 99%, of the caffeine from the caffeine-containing extraction liquid is bound to the adsorber resin,
(S3) contacting the caffeine-laden adsorber resin that arises in step S2 with dichloromethane so as to dissolve caffeine in the dichloromethane,
wherein, in step S3,
   the contacting is performed in such a way that at least 80%, preferably at least 90%, more preferably at least 95%, most preferably at least 99%, of the caffeine from the caffeine-laden adsorber resin is dissolved in the dichloromethane,
and/or (preferably “and”)
   the temperature of the dichloromethane is lower than 35° C., preferably lower than 30° C., more preferably lower than 25° C.,
wherein aqueous extraction liquid is preferably circulated once or more than once and the caffeine-depleted aqueous extraction liquid that arises in step S2 or a processing product thereof is reused as aqueous extraction liquid in step S1.

Preference is given to a process of the invention (as described above, preferably as identified above as preferred), wherein the process is a process for producing decaffeinated green coffee beans and caffeine concentrate, comprising the additional step of: (S5) obtaining caffeine concentrate from the solution of caffeine in dichloromethane after step S3, preferably by separating off caffeine.

Preferably, both the above-described step (S4) and this step (S5) are performed; the sequence of steps (S4) and (S5) here is arbitrary. But it is also possible to perform only step (S5) or only step (S4) in individual cases.

Preference is thus given to a process of the invention in which not only are decaffeinated green coffee beans obtained as product, but a caffeine concentrate is additionally obtained in step S5. The latter is obtained from the solution of caffeine in dichloromethane after step S3, preferably by separating off caffeine.

The person skilled in the art is aware of methods customary in the art for separating caffeine from a caffeinated dichloromethane solution. These especially include heating of such a caffeinated dichloromethane solution or extracting of caffeine from the caffeinated dichloromethane solution by means of another extraction liquid. In addition, caffeine can be crystallized out of the caffeinated dichloromethane solution by gradually reducing the dichloromethane content, for example by application of reduced pressure or by heating.

In a further primary aspect of the present invention, the above-specified objects are achieved, and problems are solved, by an apparatus for production of decaffeinated green coffee beans in a process of the invention (preferably in a process identified as preferred), comprising
an extractor fillable with an amount of green coffee beans for contacting the amount of caffeinated green coffee beans with an aqueous extraction liquid,
an adsorption unit containing an adsorber resin, for contacting an aqueous, caffeine-enriched extraction liquid with the adsorber resin, where the extractor is connected to the adsorption unit such that aqueous, caffeine-enriched extraction liquid can be passed from the extractor into the adsorption unit, where preference is given to using an adsorber resin that has been preladen with individual or multiple noncaffeine coffee constituents selected from the group consisting of acids, minerals, aromas, compounds convertible to aromas by Maillard reaction, and antioxidants,
a reservoir vessel for aqueous extraction liquid, connected to the extractor such that aqueous extraction liquid can be passed from the reservoir vessel for aqueous extraction liquid into the extractor, and preferably connected to the extractor such that, after an extraction operation, aqueous extraction liquid from the extractor or the adsorption unit can be recycled into the reservoir vessel, preferably from the adsorption unit,
a reservoir vessel for dichloromethane, connected to the adsorption unit such that dichloromethane can be contacted with the adsorber resin,
one or more control devices
   for controlling the supply of aqueous extraction liquid and/or of dichloromethane within the apparatus
   and/or (preferably “and”)
   for automatic switchover from step S2 to step S3 as soon as a predetermined progression of the extraction in step S1 has been attained and/or as soon as a predetermined loading of the adsorber resin with caffeine in step S2 has been attained.

An apparatus of the invention thus comprises an extractor fillable with an amount of green coffee beans for contacting of an amount of caffeinated green coffee beans with an aqueous extraction liquid (in step S1 of the process of the invention). Preferably the (entirety of) process step S1 takes place in the extractor fillable with an amount of green coffee beans, meaning that an amount of caffeinated green coffee beans is contacted with an aqueous extraction liquid in the extractor such that caffeine is extracted from the caffeinated green coffee beans into the extraction liquid.

The person skilled in the art selects the extracted here in a customary manner, taking account in particular of those properties of the extractor that are crucial for ensuring efficient contacting of the green coffee beans with the aqueous extraction liquid. These properties include the shape and size, and the implementation of stirring and mixing units within the extractor.

The extractor fillable with an amount of green coffee beans preferably has an inlet for filling with the aqueous extraction liquid. This inlet is preferably connected via pipelines to other apparatus elements, for example to a reservoir vessel or to the outlet side of the adsorption unit.

The extractor fillable with an amount of green coffee beans preferably has an outlet from which the caffeine-enriched aqueous extraction liquid can be transferred, for example, into a further apparatus element such as the adsorption unit, preferably via pipelines.

The extractor fillable with an amount of green coffee beans preferably comprises both an inlet and an outlet for the aqueous extraction liquid (as described above).

The extractor fillable with an amount of green coffee beans preferably comprises an inlet for green coffee beans and preferably a separate outlet for decaffeinated green coffee beans.

An apparatus of the invention comprises an adsorption unit containing an adsorber resin, for contacting an aqueous, caffeine-enriched extraction liquid with the adsorber resin, where the extractor is connected to the adsorption unit such that aqueous, caffeine-enriched extraction liquid can be passed from the extractor into the adsorption unit.

Process steps S2 and S3 preferably take place in this adsorption unit. The adsorption unit with an adsorber resin is configured such that it enables
i) contacting of the caffeine-enriched aqueous extraction liquid that arises in step S1 with the adsorber resin so as to bind caffeine from the extraction liquid to the adsorber resin,
and
ii) contacting of the caffeine-laden adsorber resin that arises in step S2 with dichloromethane so as to dissolve caffeine in the dichloromethane.

In an apparatus of the invention, the extractor is connected to the adsorption unit such that aqueous caffeine-enriched extraction liquid can be directed from the extractor into the adsorption unit. The extractor is connected to the adsorption unit, for example, by suitable pipeline systems between corresponding terminals (inlets or outlets) of the extractor and the adsorption unit.

The adsorption unit is preferably connected to the extractor such that aqueous, caffeine-depleted extraction liquid can be directed from the adsorption unit back into the extractor. Such a configuration is especially advantageous when a process of the invention, especially steps S1 and S2, is being performed semicontinuously in a preferred manner.

The adsorption unit is preferably configured such that a preferred process of the invention can be performed, wherein the aqueous extraction liquid is circulated once or more than once, preferably with renewed use of the caffeine-depleted aqueous extraction liquid that arises in step S2 or a processing product thereof as aqueous extraction liquid in step S1.

The exact configuration of the adsorption unit is chosen by the person skilled in the art with reference to the requirements of the individual case. An adsorption unit preferably consists of one or more adsorber columns (each) filled with adsorber resin. For use in step S2 of the process of the invention, preference is given to adsorber resins that have been preladen with individual or multiple noncaffeine coffee constituents selected from the group consisting of acids, minerals, aromas, compounds convertible to aromas by Maillard reaction, and antioxidants.

In the case that there are multiple adsorber columns filled with adsorber resin within the adsorption unit, it is preferable that these adsorber columns each have an inlet and an outlet and are arranged and connected to one another such that both an aqueous extraction liquid that has been enriched with caffeine (in a step S1) and one that has been depleted of caffeine (in a step S2) can be directed from a first adsorber column filled with adsorber resin to a second adsorber column filled with adsorber resin, etc. The exact configuration of the adsorption unit and of the adsorber columns and the choice of the type and of the amount of the adsorber resin are preferably matched to the requirements of the individual case. For instance, the size, the volume and the number of adsorber columns and the type and the amount of the adsorber resin are preferably matched to the type and amount of the green coffee beans to be decaffeinated and/or to the amount of caffeine to be extracted.

An apparatus of the invention additionally comprises a reservoir vessel for aqueous extraction liquid, connected to the extractor such that aqueous extraction liquid can be passed from the reservoir vessel for aqueous extraction liquid into the extractor. Depending on the process stage, it is possible here for the aqueous extraction liquid to have a different composition within the reservoir vessel for aqueous extraction liquid; for example, the content of coffee constituents and/or caffeine may vary in the course of the process. The configuration of the reservoir vessel for aqueous extraction liquid, especially the size and shape, will be matched by the person skilled in the art to the circumstances of the individual case.

In a preferred configuration, the apparatus of the invention is set up to convey an aqueous extraction liquid in circulation, wherein the extractor and the adsorption unit and preferably the reservoir vessel for aqueous extraction liquid are part of the circuit.

This preferred configuration of the apparatus is relevant especially when the aqueous extraction liquid (preferably in semicontinuous operation) is circulated once or more than once, preferably with reuse of the caffeine-depleted aqueous extraction liquid that arises in step S2 or a processing product thereof as aqueous extraction liquid in step S1.

An apparatus of the invention additionally comprises a reservoir vessel for dichloromethane, connected to the adsorption unit such that dichloromethane can be contacted with the adsorber resin.

In the apparatus of the invention, a dichloromethane circuit (caffeine desorption circuit) and an aqueous extraction circuit (caffeine adsorption circuit) correspond only in the region of the adsorption unit, but are otherwise separated in the construction. This means that the apparatus elements specifically provided for the dichloromethane circuit, for example the reservoir vessel for dichloromethane and conduits for passage of dichloromethane to the adsorption unit, are separated in the construction from apparatus elements specifically provided for aqueous extraction liquid, such as the extractor fillable with an amount of green coffee beans and the reservoir vessel for aqueous extraction liquid, and the feeds and drains thereof. Such a preferred configuration is advantageous especially since it can thus be assured that the dichloromethane solution used for the desorption of caffeine bound to the adsorber resin does not come into direct contact with the green coffee beans. It will be apparent that the adsorption unit filled with the adsorber resin must be accessible both to the aqueous extraction liquid and to dichloromethane.

The apparatus of the invention preferably comprises a switching device set up to switch between
a first operating state in which a caffeine-enriched aqueous extraction liquid that arises in a step S1 is contacted in the adsorption unit with an adsorber resin so as to bind caffeine from the extraction liquid to the adsorber resin

and
a second operating state in which a caffeine-laden adsorber resin that arises in a step S2 is contacted with dichloromethane so as to dissolve caffeine in the dichloromethane.

In the first operating state, the flow preferably passes through the above-elucidated aqueous extraction circuit (caffeine adsorption circuit).

In the second operating state, the flow preferably passes through the above-elucidated dichloromethane circuit (caffeine desorption circuit).

The process of the invention is preferably performed, and the apparatus of the invention operated, such that the first and second states of operation do not exist simultaneously.

When multiple independently operable adsorption columns are used within the adsorption unit, however, it may be advantageous that the first operating state exists in one or more first adsorption columns (aqueous extraction circuit or caffeine adsorption circuit), while the second operating state exists in one or more second adsorption columns (dichloromethane circuit or caffeine desorption circuit). In this case, the first adsorption columns and the second adsorption columns are operable independently of one another.

A preferred apparatus of the invention comprises a separation unit for separation of caffeine from a solution of caffeine in dichloromethane, where the apparatus is set up to convey dichloromethane from the reservoir vessel for dichloromethane to the adsorption unit and thence (after loading of dichloromethane with caffeine) to the separation unit. Dichloromethane (DCM) is separated there from caffeine and is then available (in purified form) for reuse in step (S3).

This preferred configuration is (firstly) of particular relevance in order to make step S3 efficient, i.e. the contacting of the caffeine-laden adsorber resin that arises in step S2 with dichloromethane so as to dissolve caffeine in the dichloromethane. The separation unit preferably comprises a vessel, preferably a stainless steel vessel, in which the DCM is evaporated in a controlled manner. This transfers the caffeine to a water reservoir, meaning that it is redissolved. The evaporated DCM is liquefied again, is then purified and is available for reuse in step (S3).

This preferred configuration is additionally (secondly) of relevance for the preferred step S5, i.e. for the recovery of caffeine concentrate (or of caffeine) from the solution of caffeine in dichloromethane that exists after step S3, preferably by separation of caffeine.

In an apparatus of the invention, the plant elements for dichloromethane (for example feeds and drains in the reservoir vessel for dichloromethane) and the separation unit are preferably separated from the aqueous extraction circuit. The separation unit is preferably configured such that it allows efficient separation of caffeine dissolved in dichloromethane from the caffeinated dichloromethane solution. A preferred apparatus of the invention thus permits the production of two high-quality products, namely both production of decaffeinated green coffee beans and production of caffeine or caffeine concentrate (in the separation unit mentioned).

Preference is given to an apparatus of the invention (as described above, preferably as identified above as preferred), wherein
the extractor has been filled with green coffee beans,
the reservoir vessel for aqueous extraction liquid contains an aqueous extraction liquid,
the reservoir vessel for dichloromethane contains an amount of dichloromethane

and/or (preferably “and”)
the adsorber resin is a macroporous adsorber resin selected from the group consisting of polystyrene, polydivinylbenzene and copolymers thereof with one another and with other monomers,
   wherein the macroporous adsorber resin is preferably a polystyrene or a copolymer of polystyrene, preferably a crosslinked polystyrene, more preferably a divinylbenzene-crosslinked polystyrene, most preferably a non-functionalized, nonionic and divinylbenzene-crosslinked polystyrene.

Such a preferred apparatus of the invention is prepared for the performance of the process of the invention.

A further aspect of the present invention relates to the use of an apparatus of the invention (as described above, preferably as identified above as preferred) for performance of a process of the invention (as described above, preferably as identified above as preferred). It will be apparent that the apparatus of the invention is preferably matched to the desired configuration of the process of the invention.

A further aspect of the present invention relates to the use of dichloromethane for removal of caffeine from an adsorber resin laden with caffeine and further coffee constituents,

wherein the adsorber resin is preferably a macroporous adsorber resin (as described above) selected from the group consisting of polystyrene, polydivinylbenzene and copolymers thereof with one another and with other monomers,
wherein the macroporous adsorber resin is more preferably a polystyrene or a copolymer of polystyrene, preferably a crosslinked polystyrene, more preferably a divinylbenzene-crosslinked polystyrene, most preferably a non-functionalized, nonionic and divinylbenzene-crosslinked polystyrene.

This inventive use of dichloromethane is implemented in the process of the invention in step S3. The preferred selection of the adsorber resin corresponds to that for the process of the invention; the above details are correspondingly applicable.

The inventive use of dichloromethane is preferably effected for removal of caffeine from an adsorber resin laden with caffeine and other coffee constituents in an apparatus of the invention (as described above, preferably as identified above as preferred).

A further aspect of the present invention relates to the use of an adsorber resin,
wherein the adsorber resin is preferably a macroporous adsorber resin selected from the group consisting of polystyrene, polydivinylbenzene and copolymers thereof with one another and with other monomers,
wherein the macroporous adsorber resin is more preferably a polystyrene or a copolymer of polystyrene, preferably a crosslinked polystyrene, more preferably a divinylbenzene-crosslinked polystyrene, most preferably a non-functionalized, nonionic and divinylbenzene-crosslinked polystyrene,

for adsorbing caffeine from a caffeine-enriched aqueous extraction liquid in a process for producing decaffeinated green coffee beans, wherein the caffeine-laden adsorber resin extracted from the green coffee beans is treated with dichloromethane such that caffeine is dissolved in the dichloromethane.

This inventive use of an adsorber resin is implemented in the process of the invention in steps S2 (adsorption; loading with caffeine) and S3 (treating with DCM; unloading of the caffeine).

The inventive use of an adsorber resin is preferably effected in a process of the invention (as described above, preferably as identified above as preferred) and/or (preferably “and”) in an apparatus of the invention (as described above, preferably as identified above as preferred).

Preference is given to an inventive use of an adsorber resin (as described above, preferably as identified above as preferred), wherein an adsorber resin used has been preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-containing extraction liquid that arises in step S1 to the adsorber resin.

There follows a description of further preferred or particularly preferred aspects of the invention. These aspects relate both to the process of the invention and to the apparatus of the invention and the uses of the invention (as described above, preferably as identified above as preferred). All the preferred and particularly preferred aspects that follow are suitable and intended for combination with other aspects of the invention, especially with those aspects that are identified as preferred, in the absence of anything to the contrary in the individual case.

A process of the invention for producing decaffeinated green coffee beans (as described above, preferably as identified above as preferred) preferably comprises one or more of the following steps:
filling an extractor with green coffee beans, preferably with dry green coffee beans,
heating the green coffee beans within a/the extractor, preferably heating by means of indirect jacket heating,
breaking down and/or additionally heating the green coffee beans by means of direct vapor, preferably by means of steam,
fixing a defined target temperature of the green coffee beans,
establishing a previously fixed target temperature of the green coffee beans, preferably establishing the previously fixed target temperature by addition of temperature-controlled water, aqueous solutions or steam,
saturating the green coffee beans with water, preferably saturating the green coffee beans up to a limiting moisture content of >40% by weight, more preferably of >50% by weight,
passing a temperature-controlled aqueous extraction liquid, preferably from a reservoir vessel for aqueous extraction liquid, through green coffee beans present in the/in an extractor,
passing the caffeine-enriched aqueous extraction liquid that arises in step S1 of the process of the invention through a particle filter, a decanter and/or a centrifuge, preferably a decanter, so as to remove particles from the aqueous extraction solution,
in step S2 of the process of the invention, passing the caffeine-enriched aqueous extraction liquid that arises in step S1, preferably a previously filtered extraction liquid, through an adsorber resin so as to (selectively) bind caffeine from the aqueous extraction liquid to the adsorber resin,
recycling the caffeine-depleted aqueous extraction liquid that arises in step S2 of the process of the invention to the extractor and using the recycled caffeine-depleted aqueous extraction liquid for (re) extraction of caffeine from caffeinated green coffee beans (the same batch as in the previous step S1 or a new batch of caffeinated green coffee beans),
removing the aqueous extraction liquid from the/an extractor, preferably removing after a defined extraction time or after a previously defined and attained progression of the extraction, preferably determined by measuring the caffeine concentration in the aqueous extraction liquid or by determining the decaffeination level of the green coffee beans,
transferring the decaffeinated, still-moist green coffee beans from the extractor to a dryer,
drying the moist decaffeinated green coffee beans, preferably in a dryer,
transferring an aqueous extraction liquid to a reservoir vessel for storage of aqueous extraction liquids, preferably after step S2 of a process of the invention,
storing an aqueous extraction liquid in a reservoir vessel for storage of aqueous extraction liquids, where the stored aqueous extraction liquid preferably arises from step S1 or from step S2 of a process of the invention,
sterilizing an aqueous extraction liquid used in a process of the invention, especially in steps S1 and S2, preferably by a PEF treatment (PEF=pulsed electrical fields),
sterilizing the aqueous extraction liquid by PEF treatment, where the aqueous extraction liquid is preferably circulated in a separate sterilization circuit and subjected to a PEF treatment within that separate circuit,
removing dissolved free asparagine from an aqueous extraction liquid used in the process of the invention, preferably an aqueous extraction liquid as exists immediately before step S1 or immediately after step S1 or immediately after step S2, preferably by adding an enzyme solution comprising asparaginase,

By removing free asparagine from the aqueous extraction solution (and hence also the removing of free asparagine from the treated green coffee beans), it is possible to distinctly reduce acrylamide formation on subsequent roasting of the decaffeinated green coffee beans produced from the process of the invention.
providing one or more column modules filled with an adsorber resin, preferably an adsorber resin laden with individual or multiple noncaffeine coffee constituents,
periodically regenerating the adsorber resin, preferably where the periodic regeneration of the adsorber resin follows complete saturation of the adsorber resin with caffeine,
regenerating the adsorber resin by rinsing with one or more solvents, preferably by rinsing in a predetermined sequence with different solvents, more preferably by rinsing the adsorber resin with solvents selected from the group consisting of organic solvents, especially dichloromethane and/or alcohols, water and steam,
transferring caffeine leached from the adsorber resin into DCM in step S3 of a process of the invention into a separation unit,
processing the leached caffeine in a caffeine processing plant so as to obtain caffeine or a caffeine extract,
redissolving caffeine leached in step S3 of a process of the invention from a caffeinated dichloromethane solution, where the redissolving of caffeine is preferably effected by means of a liquid-liquid extraction, more preferably by transferring the caffeine to an aqueous caffeinated solution by redissolution from the caffeinated dichloromethane solution,
   processing and/or reusing steam used in a process of the invention,
   processing and/or reusing dichloromethane used in a process of the invention,
   processing and/or reusing an aqueous extraction liquid used in a process of the invention,
   processing and/or reusing a rinse solution used in a process of the invention,
   reusing, preferably repeatedly reusing, an aqueous extraction liquid used in a process of the invention,
   wastewater treatment of an aqueous extraction liquid used in a process of the invention, preferably by effecting the wastewater treatment only when the aqueous extraction liquid cannot or should not be reused in a process of the invention on account of contamination (for example after repeated use in a process of the invention).

A preferred process of the invention for producing decaffeinated green coffee beans comprises one or more of the following steps, where the respective condition or status of the adsorber resin is specified between square brackets:
i. (especially on startup of the process) producing or providing a suitable adsorber resin [adsorber resin]
ii. (especially on startup of the process) saturating or loading the adsorber resin with noncaffeine coffee constituents, where the saturation or loading is preferably attained in the course of operation of the process [adsorber resin+coffee constituents]; this step ii is preferably performed before step S2 of the process of the invention
iii. passing a caffeinated aqueous extraction liquid through the adsorber resin presaturated with noncaffeine coffee constituents so as to bind caffeine to the adsorber resin from the extraction liquid [adsorber resin+coffee constituents+caffeine], preferably in or as step S2 of the process of the invention
iv. contacting the caffeine-laden adsorber resin that arises in step iii. with dichloromethane so as to dissolve caffeine in the dichloromethane, preferably by dissolution in dichloromethane via selective desorption of the caffeine from the adsorber resin [adsorber resin+coffee constituents+DCM], preferably in or as step S3 of the process of the invention
V. removing dichloromethane from the adsorber resin and regenerating the adsorber resin [adsorber resin+coffee constituents], preferably after step S3 of the process of the invention
vi. periodically thoroughly cleaning the adsorber resin with a sodium hydroxide solution.

It should be noted that the above-specified process steps i. and ii. are preferably performed only when a process of the invention is being started up, for example on an industrial scale. Process steps i. and ii. are required or advisable especially when an adsorber resin is being put into operation for the first time. The process steps or conditions of the adsorber resin in steps iii. to vi. relate more particularly to the (repetitive) performance of a process of the invention within a continuous or semicontinuous process for producing decaffeinated green coffee beans. In particular, performance of steps iii to v is preferred, irrespective of the performance or nonperformance of steps i, ii and vi.

The choice of a suitable adsorber resin may be tested by preliminary tests in the laboratory and with the aid of performance of experiments in a pilot plant.

In the process of the invention, the adsorber resin is preferably rinsed and/or softened with water prior to the first period on stream, preferably for a period of at least one hour. It is further preferable that the adsorber resin is rinsed again with water after this rinsing or softening phase in order to eliminate possible production residues (disruptive substances). In addition, the renewed rinsing operation with water serves to displace trapped air from the adsorber resin, especially trapped air from the macropores.

Preference is given to a process of the invention having the following (additional) step:
ii. saturating or loading an adsorber resin with noncaffeine coffee constituents (this step
ii is preferably performed prior to step S2 of the process of the invention):

The loading or saturating of the adsorber resin with noncaffeine coffee constituents can be effected here in at least two different ways:

In a first variant, the adsorber resin is laden with coffee constituents by flow of a previously produced coffee extract (water with added coffee constituents, where the coffee constituents are not caffeine) over the adsorber resin and binding of the coffee constituents present in the coffee extract produced beforehand to the adsorber resin. This variant is employed especially in the case of the (first) period on stream for new adsorber resin that has not yet been laden, in order to reduce the adsorption of noncaffeine water-soluble constituents from the aqueous extraction solution on the adsorber resin.

A second variant of saturation or loading of the adsorber resin with coffee constituents involves treating an adsorber resin laden or saturated both with coffee constituents and with caffeine by means of dichloromethane so as to selectively remove caffeine but leave the other coffee constituents bound at least for the most part to the adsorber resin. This second variant is performed especially when an inventive process step S2 has already been conducted. Under some circumstances, it may then be advisable to condition the adsorber resin with caffeine from an aqueous extraction liquid prior to (re) loading with caffeine. The term “conditioning” includes, for example, process steps such as rehydration by purging with water, steam or aqueous solutions.

Preference is given to a process of the invention having the following (additional) step:
iii. passing a caffeinated aqueous extraction liquid through the adsorber resin presaturated with noncaffeine coffee constituents so as to bind caffeine to the adsorber resin from the extraction liquid (preferably in or as step S2 of the process of the invention):
Step iii. in the decaffeination process brings about what is called the “loading” of the adsorber resin with caffeine.

Additional or renewed loading with noncaffeine coffee constituents is likewise possible. Such additional or renewed loading with noncaffeine coffee constituents is advisable especially when periodic thorough cleaning of the adsorber resin conducted beforehand has desorbed (leached) portions of the noncaffeine coffee constituents from the adsorber resin.

The caffeinated aqueous extraction liquid directed through the adsorber resin in step iii. is preferably produced/obtained as follows:
a particular amount of green coffee beans is introduced into an extractor
the extractor filled with a particular amount of green coffee beans is filled with an aqueous extraction liquid, preferably with an aqueous extraction liquid which is caffeine-free or has a low caffeine level but is saturated with other coffee constituents until the green coffee beans are covered
In the special case of an extraction for the first time in which there is not yet any aqueous extraction liquid (saturated with coffee constituents) available, the green coffee beans may be covered with previously produced coffee extract or with water
By means of stirring, preferably by means of stirring by a stirrer system in the extractor, the mixture of green coffee beans and aqueous extraction liquid is mixed in order to ensure effective extraction of the caffeine from the green coffee beans
The low-caffeine or caffeine-free aqueous extraction liquid extracts caffeine from the green coffee beans so as to result in a caffeinated aqueous extraction liquid; this last component step is preferably performed in or as step S1 of a process of the invention.

The passing of a caffeinated aqueous extraction liquid through the adsorber resin presaturated with noncaffeine coffee constituents so as to bind caffeine to the adsorber resin from the extraction liquid in step iii. preferably comprises one or more of the following measures:
The caffeinated aqueous extraction liquid is passed through one or more adsorber resin-filled adsorber columns, preferably through at least two adsorber resin-filled adsorber columns
The caffeinated aqueous extraction liquid is passed through two adsorber resin-filled adsorber columns,
   wherein the caffeinated aqueous extraction liquid preferably flows first through a first adsorber resin-filled adsorber column until this first adsorber resin-filled adsorber column is laden with caffeine, preferably saturated with caffeine, and then the caffeinated aqueous extraction liquid flows through a second likewise adsorber resin-filled adsorber column until this second adsorber resin-filled adsorber column is also laden with caffeine, preferably saturated with caffeine
The caffeinated aqueous extraction liquid is passed through multiple series-connected adsorber resin-filled adsorber columns, where the caffeinated aqueous extraction liquid flows through only one or some of the multiple series-connected adsorber resin-filled adsorber columns in each case, while one or more of the other adsorber resin-filled adsorber columns through which no flow has passed
   i) are flushed with dichloromethane in order to (selectively) leach caffeine from the adsorber resin
   and/or
   ii) are regenerated, preferably by flushing with water, steam and/or sodium hydroxide-containing solutions

It is preferable that the adsorber resin presaturated with noncaffeine coffee constituents has been laden with caffeine, preferably saturated with caffeine, after step iii. has ended.

It is preferable that the low-caffeine or caffeine-free aqueous extraction liquid that likewise arises as a result of step iii. is directed again into the extractor filled with green coffee beans, optionally after further processing (especially comprising the separation or addition of further constituents) in order to extract caffeine from the green coffee beans (cycle process).

It is preferable to conduct step iii. until a desired degree of decaffeination of the green coffee beans has been attained. More preferably, step iii. is performed in such a way that, in the adsorber resin-filled adsorber columns used in the process, there is (repeated) switching between loading cycles (passage of aqueous extraction liquid, preferably passage within a circulation system) and caffeine desorption and regeneration cycles. An adsorber resin-filled adsorber column may thus either be in caffeine adsorption circulation (loading with caffeine), in caffeine desorption circulation (dissolving of caffeine) or in regeneration circulation, and may be switched from one first circulation to any other circulation by controlled switching.

Preference is given to a process of the invention having the following (additional) step:
iv. contacting the caffeine-laden adsorber resin that arises in step iii. with dichloromethane so as to dissolve caffeine in the dichloromethane, preferably by dissolution in dichloromethane via selective desorption of the caffeine from the adsorber resin (preferably in or as step S3 of the process of the invention):

The effect of step iv. in the decaffeination process is the so-called “unloading” of the adsorber resin, especially the unloading (desorption) of caffeine bound to adsorber resin. An additional effect of step iv. is that the adsorber resin is again capable of being loaded with caffeine.

The desorption should proceed as selectively as possible in order that preferably only caffeine is desorbed from the caffeine-laden adsorber resin that arises in step iii, and the noncaffeine coffee constituents remain bound to the adsorber resin. For such selective desorption, dichloromethane (DCM) is used in step S3 of the process of the invention.

It is preferable that the caffeine-laden adsorber resin that arises in step iii. is present in an adsorber column. It is especially preferable that the adsorber resin-filled adsorber column, before being contacted with dichloromethane in step iv., is cooled down to a temperature of lower than 25° C. by contacting, preferably by purging, with an aqueous extraction liquid, water or some other aqueous solution.

Step iv. is preferably effected by passage of DCM, more preferably by passage of DCM in the opposing direction to the flow direction with which the aqueous extraction liquid has been passed through the adsorber resin in step iii. However, passage in the same flow direction is also advantageous in individual cases.

Preference is given to a process of the invention having the following (additional) step:
V. removing dichloromethane from the adsorber resin and/or regenerating the adsorber resin, preferably in or as step S4 of a preferred process of the invention:

Preferably, between step iv. (caffeine desorption by DCM) and another performance of step iii. (caffeine adsorption from an aqueous extraction liquid), dichloromethane is removed from the adsorber resin and/or the adsorber resin is regenerated (step v.).

This (additional) step v., especially the removing of DCM from the adsorber resin, is effected, for example, in order to rule out contamination of the green coffee beans with DCM and hence to allow the adsorber resin to be fully laden again with caffeine. After step iv., there is regularly “free” (unadsorbed) DCM in the adsorber resin, both externally and in the pores of the adsorber resin. In addition, portions of the dichloromethane used in step iv. may have been adsorbed on the surface of the adsorber resin.

The following measures in particular are available for removal of DCM from the adsorber resin, which may be performed in any sequence and as often as desired:
removing of “free” (unadsorbed) DCM that is not present in pores from the adsorber resin by
   passing water through the adsorber resin
removing “free” (unadsorbed) DCM from the pores of the adsorber resin by
   passing water, preferably water at a temperature of greater than 50° C., through the adsorber resin
   passing steam through the adsorber resin
removing DCM adsorbed on the surface of the adsorber resin by
   passing water, preferably water at a temperature of greater than 50° C., through the adsorber resin
   passing steam through the adsorber resin.

When DCM is removed from the adsorber resin, water should preferably be used as little as possible since water and aqueous solutions can likewise desorb some of the adsorbed noncaffeine coffee constituents.

The adsorber resin is preferably regenerated after repeated circulation, in which case DCM is preferably removed from the adsorber resin immediately beforehand. The following measures are available for regeneration of the adsorber resin, which may performed in any sequence and as often as desired:
rinsing the adsorber resin with water, aqueous solutions or aqueous extraction liquid
removing trapped gas by rinsing the adsorber resin with water, aqueous solutions or aqueous extraction liquid

It is preferable that regeneration of the adsorber resin takes place only after DCM is first (very substantially) removed from the adsorber resin. It is especially preferable that, at the end of step v., the adsorber resin is rehydrated, preferably by rehydrating by rinsing the adsorber resin with water, aqueous solutions or aqueous extraction liquid.

Preference is given to a process of the invention having the following (additional) step:
vi. periodically thoroughly cleaning the adsorber resin with a sodium hydroxide solution.

Especially after repeatedly performing process steps iii. to v., thorough cleaning of the adsorber resin with a sodium hydroxide solution is advisable in order to regain, or sustainably maintain, the full caffeine loading capacity of the adsorber resin.

The invention is elucidated in detail hereinafter with reference to the appended figures.

### THE FIGURES SHOW

FIG. 1: schematic construction of an apparatus of the invention for production of decaffeinated green coffee beans.

FIG. 2: schematic diagram of a (first) process of the invention for production of decaffeinated green coffee beans.

FIG. 3: schematic diagram of a (second) process of the invention for production of decaffeinated green coffee beans.

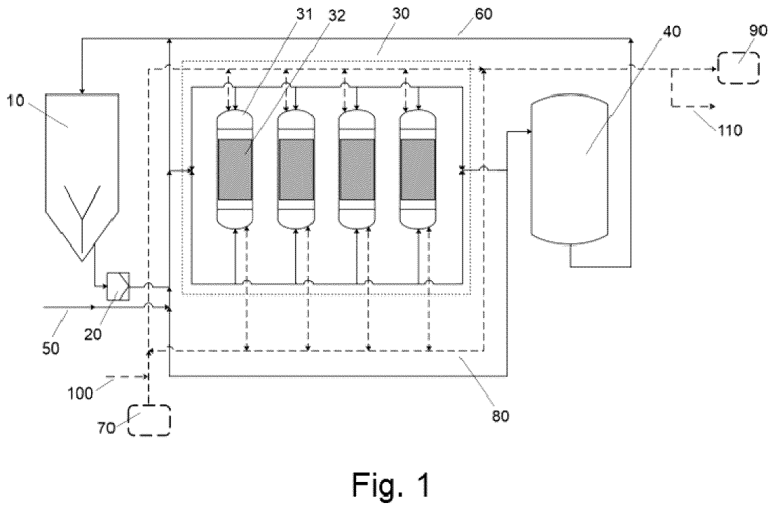

FIG. 1 shows, by way of example, the schematic construction of a preferred apparatus of the invention for production of decaffeinated green coffee beans. The apparatus shown in FIG. 1 comprises the following elements: extractor 10, separator 20, adsorption unit 30, adsorber column filled with adsorber resin 31, adsorber resin 32, reservoir vessel for aqueous extraction liquid 40, inlet for aqueous extraction liquid 50, caffeine adsorption circuit for aqueous extraction liquid 60, reservoir vessel for dichloromethane 70, caffeine desorption circuit for dichloromethane and/or caffeinated dichloromethane solution or regeneration circuit for rinse solutions 80, separation unit 90, inlet for rinse solutions 100, outlet for rinse solutions 110.

An apparatus of the invention is not of course restricted to the configuration shown in FIG. 1. An apparatus of the invention may comprise, for example, additional elements that are not shown in FIG. 1. It is also possible for the arrangement and/or the number of individual elements in an apparatus of the invention to differ from the apparatus shown in FIG. 1.

The apparatus shown in FIG. 1 is in particular suitable and intended (like any apparatus of the invention) to perform a process of the invention for production of decaffeinated green coffee beans having the following steps:
(S1) contacting an amount of caffeinated green coffee beans with an aqueous extraction liquid so as to extract caffeine from the caffeinated green coffee beans into the extraction liquid,
(S2) contacting the caffeine-enriched aqueous extraction liquid that arises in step S1 with an adsorber resin so as to bind caffeine from the extraction liquid to the adsorber resin,
(S3) contacting the caffeine-laden adsorber resin that arises in step S2 with dichloromethane so as to dissolve caffeine in the dichloromethane.

The preferred apparatus shown in FIG. 1 for production of decaffeinated green coffee beans, preferably for production of decaffeinated green coffee beans in a process of the invention comprising steps S1, S2 and S3, comprises:
an extractor 10 fillable with an amount of green coffee beans for contacting the amount of caffeinated green coffee beans with an aqueous extraction liquid,
a separator 20 for separation of solid constituents out of the aqueous extraction liquid after extraction of the caffeinated green coffee beans. The separator need not be provided in every apparatus of the invention; this is correspondingly applicable to all apparatus elements not mentioned in the definition of the apparatus of the invention in the claims,
an adsorption unit 30 having an adsorber resin 32 (in adsorber columns 31, more of which shortly), for contacting of an aqueous, caffeine-enriched extraction liquid with the adsorber resin 32. The extractor here, according to FIG. 1, is connected via the separator 20 to the adsorption unit 30 in such a way that aqueous, caffeine-enriched extraction liquid can be directed from the extractor 10 into the adsorption unit 30,
adsorber columns 31 filled with the adsorber resin 32 within the adsorption unit 30. The adsorber columns are provided for passage of aqueous extraction liquid. The adsorber resin 32 is preferably a macroporous adsorber resin selected from the group consisting of polystyrene, polydivinylbenzene and copolymers thereof with one another and with other monomers, where the macroporous adsorber resin is preferably a polystyrene or a copolymer of polystyrene, preferably a crosslinked polystyrene, more preferably a divinylbenzene-crosslinked polystyrene, most preferably a nonfunctionalized, nonionic and divinylbenzene-crosslinked polystyrene,
a reservoir vessel 40 for aqueous extraction liquid, connected to the extractor 10 such that aqueous extraction liquid (according to FIG. 1 via corresponding conduits) can be passed from the reservoir vessel 40 for aqueous extraction liquid into the extractor 10,
an inlet for aqueous extraction liquid 50, which is connected to the extractor 10, the adsorption unit 30 and the reservoir vessel 40 for aqueous extraction liquid (according to FIG. 1 via corresponding conduits) in such a way that aqueous extraction liquid can be directed from the inlet for aqueous extraction liquid 50 into the respective elements,
a reservoir vessel 70 for dichloromethane, connected to the adsorption unit 30 such that dichloromethane can be contacted with the adsorber resin 32,
a separation unit 90 for separation of caffeine from a dichloromethane solution,
an inlet for rinse solutions 100, which is connected to a caffeine desorption circuit (see below) for dichloromethane and/or caffeinated dichloromethane solution or a regeneration circuit (see below) for rinse solutions 80 and the adsorption unit 30 in such a way that rinse solutions can be directed from the inlet for rinse solutions 100 into the adsorption unit 30,
an outlet for rinse solutions 110 which is connected to the caffeine desorption circuit for dichloromethane and/or caffeinated dichloromethane solution or regeneration circuit for rinse solutions 80 and the adsorption unit 30 in such a way that rinse solutions from the adsorption unit 30 can be discharged from the apparatus via the outlet for rinse solutions 110,
one or more conveying devices for conveying liquid within the apparatus (not depicted in FIG. 1),
one or more valve devices for controlled opening and closing of conduits, conduit sections and other apparatus elements (not depicted in FIG. 1),
one or more control devices (not depicted in FIG. 1)
   for controlling the conveying of aqueous extraction liquid and/or of dichloromethane within the apparatus (the control devices interact here in a customary manner with the conveying devices and the valve devices such that the process of the invention can be performed in the apparatus of the invention)
   and/or
   for automatic switching from step S2 to step S3 in the process of the invention as soon as a predetermined progression of the extraction in step S1 has been attained and/or as soon as a predetermined loading of the adsorber resin 32 with caffeine in step S2 has been attained (the control devices interact here with one or more measurement and analysis devices that determine the progress of the extraction or the loading state).

The apparatus of the invention shown in FIG. 1 is set up to convey an aqueous extraction liquid in circulation, where the extractor 10, the adsorption unit 30 and the reservoir vessel 40 for aqueous extraction liquid are part of the circuit (caffeine adsorption circuit 60). By means of a bypass conduit (not shown), it is alternatively possible to bypass the reservoir vessel.

The apparatus of the invention shown in FIG. 1 is additionally set up to convey dichloromethane and/or caffeinated dichloromethane solution through the adsorption unit 30, preferably in the circuit 80 (here: caffeine desorption circuit 80). Dichloromethane is conveyed here out of the reservoir vessel 70 for dichloromethane to the adsorption unit 30 and thence to the separation unit 90. The apparatus is additionally set up to convey rinse solutions in the circuit 80 through the adsorption unit 30 (here: regeneration circuit 80). Rinse solution is introduced here into the circuit through the inlet 100 and, after rinsing has been completed, removed through the outlet 110.

The apparatus of the invention shown in FIG. 1 comprises a separation unit 90 for separation of caffeine from a solution of the caffeine in dichloromethane and is set up to convey dichloromethane from the reservoir vessel 70 for dichloromethane to the adsorption unit 30 and thence to the removal unit 90.

In the apparatus of the invention according to FIG. 1, the caffeine adsorption circuit for aqueous extraction liquid 60, set up to circulate an aqueous extraction liquid, and the caffeine desorption circuit for dichloromethane and/or caffeinated dichloromethane solution or the regeneration circuit for purge solutions 80 correspond in the region of the adsorption unit 30, but are otherwise separated in the construction. Apparatus elements that are provided specifically for the caffeine desorption circuit for dichloromethane and/or caffeinated dichloromethane solution or for the regeneration circuit for purge solutions 80, i.e. in particular the reservoir vessel for dichloromethane 70 and conduits for passage of dichloromethane to the adsorption unit 30, are likewise separated in the construction from apparatus elements provided specifically for the caffeine adsorption circuit for aqueous extraction liquid, such as the extractor 10 fillable with an amount of green coffee beans and the reservoir vessel 40 for aqueous extraction liquid and the inlets and outlets thereof. Such a configuration is advantageous especially because it can thus be assured that the dichloromethane solution used for desorption of caffeine bound to the adsorber resin does not come into direct contact with the green coffee beans present in the extractor 10.

In the apparatus of the invention as per FIG. 1, process step S1 of the process of the invention, i.e. the contacting of an amount of caffeinated green coffee beans with an aqueous extraction liquid such that caffeine is extracted from the caffeinated green coffee beans to the extraction liquid takes place within the extractor 10. For this purpose, the extractor 10 is filled with green coffee beans. In addition, the extractor is equipped with inlets and outlets for the input and output of an aqueous extraction liquid. The aqueous extraction liquid is fed into the extractor 10 within the caffeine adsorption circuit 60 for aqueous extraction liquid through one or more conduits that are fed with aqueous extraction liquid either from the reservoir vessel 40 for aqueous extraction liquid and/or the adsorption unit 30.

In the apparatus of the invention as per FIG. 1, process step S2 of the process of the invention takes place within the adsorption unit 30, i.e. the contacting of the caffeine-enriched aqueous extraction liquid that arises in step S1 with an adsorber resin 32, such that caffeine from the extraction liquid is bound to the adsorber resin 32. For this purpose, the adsorber columns 31 within the adsorption unit 30 are filled with adsorber resin 32, preferably with an adsorber resin 32 preladen with individual or multiple noncaffeine coffee constituents selected from the group consisting of acids, minerals, aromas, compounds convertible to aromas by Maillard reaction, and antioxidants. The caffeine-enriched aqueous extraction liquid that arises in step S1 is directed from the extractor 10 by corresponding conduits into the adsorption unit 30, where it is contacted with adsorber resin 32. In this context, corresponding conduits within the adsorption unit 30, especially conduits between the adsorber columns 31 filled with adsorber resin 32, ensure the passage of the caffeine-enriched aqueous extraction liquid through the adsorber resin 32. The aqueous extraction liquid that has been enriched with caffeine prior to step S2 is depleted of caffeine by the contacting with adsorber resin 32; the adsorber resin 32 binds/adsorbs the caffeine from the aqueous extraction liquid. The caffeine-depleted aqueous extraction liquid that arises after step S2 is preferably fed back to the extractor 10 via appropriate conduits, in order to be used there again for process step S1 of the process of the invention (circulation process via the caffeine adsorption circuit 60 for aqueous extraction liquid).

In the apparatus of the invention as per FIG. 1, process step S3 of the process of the invention takes place within the adsorption unit 30, i.e. the contacting of the caffeine-laden adsorber resin 32 that arises in step S2 with dichloromethane so as to dissolve caffeine in the dichloromethane. The configuration of the adsorption unit 30 that has been set out in step S2 is correspondingly applicable here. For contacting with the caffeine-laden adsorber resin 32, dichloromethane is directed from the reservoir vessel 70 for dichloromethane via appropriate conduits into the adsorption unit 30, where it is contacted with the caffeine-laden adsorber resin 32. In this context, corresponding conduits within the adsorption unit 30, especially conduits between the adsorber columns 31 filled with adsorber resin 32, ensure the passage of dichloromethane through the adsorber resin 32. The adsorber resin 32 that has been laden with caffeine prior to step S3 desorbs caffeine when dichloromethane is passed through, such that caffeine is dissolved in the dichloromethane and results in a caffeinated dichloromethane solution. This caffeinated dichloromethane solution that results after step S3 is preferably conveyed via appropriate conduits from the adsorption unit 30 to the separation unit 90 (see caffeine desorption circuit 80 in FIG. 1).

In the apparatus of the invention according to FIG. 1, the optional (additional) process step S4 takes place, i.e. the treating of the adsorber resin 32 to remove dichloromethane and/or to regenerate the loadability of the adsorber resin 32 with caffeine likewise takes place in the adsorption unit 30 under the conditions of step S2. The conduit system of the caffeine desorption circuit 80 (here: regeneration circuit 80) is preferably used for passage of corresponding (preferably heated, aqueous) rinse solutions or of steam through the adsorber resin 32. Corresponding rinse solutions are introduced into the regeneration circuit 80 in this case through the inlet 100, fed to the adsorption unit 30 and, on completion of treatment of the adsorber resin 32 for removal of dichloromethane and/or for regeneration of the adsorber resin 32, removed from the apparatus through the outlet 110.

Corresponding conveying devices (not depicted in FIG. 1) for conveying of liquid within the apparatus, valve devices for controlled opening and closing of conduits, conduit sections and other apparatus elements, and control devices for controlling the conveying of aqueous extraction liquid and/or dichloromethane and/or rinse solutions within the apparatus ensure that the caffeine adsorption circuit 60 for aqueous extraction liquid and the caffeine desorption circuit for dichloromethane and/or caffeinated dichloromethane solution or the regeneration circuit for rinse solutions 80 are separated from one another. It is thus possible to completely or at least substantially avoid direct contact of the green coffee beans present in the extractor 10 with dichloromethane and/or rinse solutions. In this way, contamination of the green coffee beans with dichloromethane is completely or at least largely avoided. This is a particularly crucial aspect of the present invention, especially with regard to the above-described consumer concerns with regard to organic solvent residues in coffee products.

At the same time, with the apparatus of the invention according to FIG. 1, the aqueous extraction liquid can be circulated once or more than once, preferably with reuse of the caffeine-depleted aqueous extraction liquid that arises in step S2 or a processing product thereof as aqueous extraction liquid in step S1. This leads to a particularly efficient water decaffeination process.

The apparatus shown in FIG. 1 is additionally illustrative of the use of a suitable adsorber resin in a process of the invention as a kind of “intermediate caffeine storage medium” with the technically advantageous two-stage extraction sequence, newly developed here, of “liquid-solid” (loading step S2; aqueous extraction liquid/adsorber resin) plus “solid-liquid” (unloading step S3; laden adsorber resin/DCM) for removal and obtaining of caffeine from an aqueous extraction liquid and hence for efficient production of high-quality decaffeinated green coffee beans.

### LIST OF REFERENCE NUMERALS FOR FIG. 1

10 extractor
20 separator
30 adsorption unit
31 adsorber column filled with adsorber resin
32 adsorber resin
40 reservoir vessel for aqueous extraction liquid
50 inlet for aqueous extraction liquid
60 caffeine adsorption circuit for aqueous extraction liquid
70 reservoir vessel for dichloromethane
80 caffeine desorption circuit for dichloromethane and/or caffeinated dichloromethane
solution or regeneration circuit for rinse solutions
90 separation unit
100 inlet for rinse solutions
110 outlet for rinse solutions

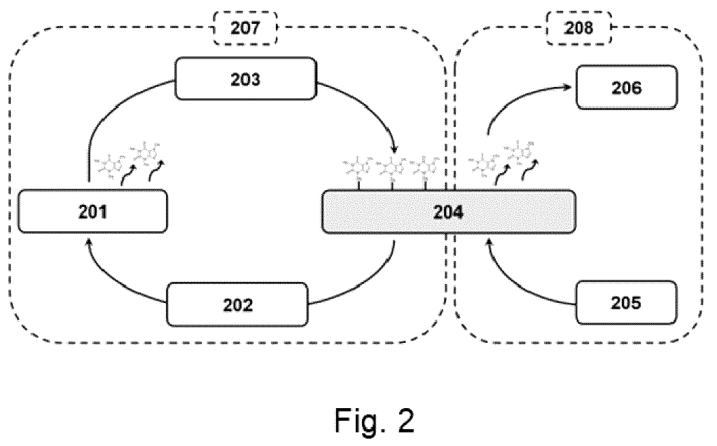

FIG. 2 shows, in the schematic flow diagram, a first embodiment of a process of the invention for production of decaffeinated green coffee beans. Preferably, the process of the invention for producing decaffeinated green coffee beans is conducted in an apparatus of the invention for production of decaffeinated green coffee beans (as described above, preferably as identified above as preferred), for example in an apparatus according to FIG. 1 (see the corresponding description).

In a first step S1 of the process, an amount of caffeinated green coffee beans 201 is contacted with an aqueous extraction liquid 202 so as to extract caffeine from the caffeinated green coffee beans 201 into the extraction liquid. The caffeine-enriched aqueous extraction liquid 203 that arises in step S1, i.e. the contacting with the caffeinated green coffee beans 201, is contacted in a next step S2 with an adsorber resin 204 so as to bind caffeine from the caffeine-enriched aqueous extraction liquid 203 to the adsorber resin 204.

The adsorber resin 204 used in step S2 is preferably a macroporous adsorber resin selected from the group consisting of polystyrene, polydivinylbenzene and copolymers thereof with one another and with other monomers, where the macroporous adsorber resin is preferably a polystyrene or a copolymer of polystyrene, preferably a crosslinked polystyrene, more preferably a divinylbenzene-crosslinked polystyrene, most preferably a nonfunctionalized, nonionic and divinylbenzene-crosslinked polystyrene.

The adsorber resin 204 used in step S2 has preferably been preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-enriched aqueous extraction liquid 203 to the adsorber resin 204.

The aqueous extraction liquid, after being contacted with the adsorber resin 204 as caffeine-depleted aqueous extraction solution 202, is preferably contacted again with an amount of caffeinated green coffee beans 201 so as to extract caffeine from the caffeinated green coffee beans 201 into the extraction liquid.

The aqueous extraction liquid 202/203 is more preferably circulated once or more than once in a continuous or semicontinuous process (aqueous extraction circuit 207), wherein the caffeine-depleted aqueous extraction liquid 202 or a processing product thereof is preferably used again once or more than once as aqueous extraction liquid for extraction of caffeine from the caffeinated green coffee beans 201.

In a further step of the process (corresponding to a specific step S3 of the process of the invention), the caffeine-laden adsorber resin 204 is contacted with dichloromethane 205 so as to dissolve caffeine in the dichloromethane and result in a caffeinated dichloromethane solution 206 (desorption of caffeine bound to the adsorber resin in caffeine desorption step 208). The resulting caffeinated dichloromethane solution 206 is preferably fed to a separation unit (not shown in FIG. 2) in order to obtain caffeine or caffeine concentrate from the caffeinated dichloromethane solution 206.

By means of the process shown in FIG. 2, it is thus possible to obtain decaffeinated green coffee beans (by process steps in the aqueous extraction circuit 207) and additionally caffeine or caffeine concentrate (by process steps in the caffeine desorption step 208) as product. The process of the invention is thus particularly economically viable since, in a manner which is efficiently implementable from a process engineering point of view, not just one but two high-quality and valuable products are (can be) produced, namely decaffeinated green coffee beans (first product) and caffeine or caffeine extract (second product).

The green coffee beans 201 do not come into direct contact here with dichloromethane 205. In this way, contamination of the green coffee beans 201 with dichloromethane 205 is completely or at least largely avoided. This is a particularly crucial aspect of the present invention, especially with regard to the above-described consumer concerns with regard to organic solvent residues in coffee products.

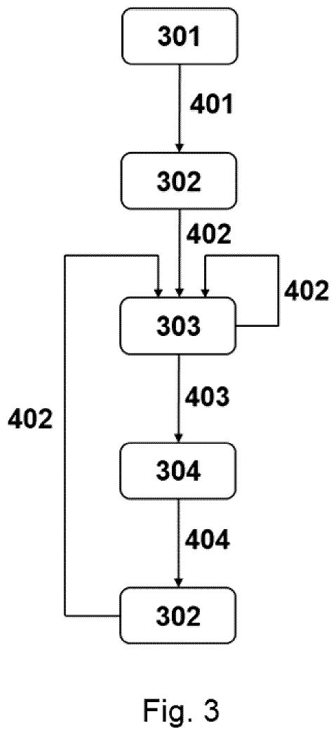

FIG. 3 shows, in the flow diagram, a further embodiment of a process of the invention for production of decaffeinated green coffee beans. Preferably, this process of the invention for producing decaffeinated green coffee beans is conducted in a plant of the invention for production of decaffeinated green coffee beans (as described above, preferably as identified above as preferred), for example in an apparatus according to FIG. 1 (see the corresponding description).

In a first step 401 of the process shown in FIG. 3, a produced or provided adsorber resin 301 is preladen, preferably saturated, with individual or multiple noncaffeine coffee constituents. Preferably, step 401 is effected by contacting an aqueous solution produced or provided, comprising individual or multiple noncaffeine coffee constituents selected from the group consisting of acids, minerals, aromas, compound convertible to aromas by Maillard reaction, and antioxidants with the adsorber resin 301 produced or provided so as to result in an adsorber resin 302 preladen with coffee constituents that has been preladen with individual or multiple noncaffeine coffee constituents selected from the group consisting of acids, minerals, aromas, compounds convertible to aromas by Maillard reaction, and antioxidants.

The adsorber resin 301 produced or provided here is preferably a macroporous adsorber resin selected from the group consisting of polystyrene, polydivinylbenzene and copolymers thereof with one another and with other monomers, where the macroporous adsorber resin is preferably a polystyrene or a copolymer of polystyrene, preferably a crosslinked polystyrene, more preferably a divinylbenzene-crosslinked polystyrene, most preferably a nonfunctionalized, nonionic and divinylbenzene-crosslinked polystyrene.

In a next step 402 of the process (corresponding to a specific step S2 of the process of the invention), the adsorber resin 302 preladen with coffee constituents is contacted with a caffeine-enriched aqueous extraction liquid, where this caffeine-enriched aqueous extraction liquid has been obtained by prior contacting of an aqueous extraction liquid (which has not yet been enriched with caffeine) with an amount of caffeinated green coffee beans (corresponding to the previous performance of a step S1 of the process of the invention). By contacting of the adsorber resin 302 that has been preladen with coffee constituents with the caffeine-enriched aqueous extraction liquid in step 402, caffeine from the extraction liquid is bound to the adsorber resin, so as to result in an adsorber resin 303 laden with coffee constituents and caffeine.

Step 402 is preferably performed once or more than once in a continuous or semicontinuous process, more preferably a sufficient number of times to achieve a predetermined loading of the adsorber resin with caffeine, most preferably a sufficient number of times for the adsorber resin to be saturated with caffeine. Repeated performance is indicated schematically in FIG. 3 by a process line with reference 402 that proceeds from the adsorber resin 303 laden with coffee constituents and caffeine and is returned thereto.

In a next step 403 of the process, the adsorber resin 303 that has been laden with coffee constituents and caffeine is contacted with dichloromethane, such that caffeine is dissolved in the dichloromethane and this results in a form of the adsorber resin 304 laden with coffee constituents and rinsed with dichloromethane (corresponding to a specific step S3 of the process of the invention).

A next step 404 of the process involves treating the form of the adsorber resin 304 that has been laden with coffee constituents and rinsed with dichloromethane. This step 404 comprises the removing of dichloromethane and/or (preferably “and”) the regenerating of the loadability of the adsorber resin with caffeine for preparation for a (new) process step 402. Step 404 is preferably conducted in such a way that the adsorber resin is converted thereby to the form 302 preladen with coffee constituents and can be reused in a process step 402, i.e. reused for binding of caffeine from a caffeinated aqueous extraction solution.

The reuse of the adsorber resin in its form 302 preladen with coffee constituents in process step 402 is indicated schematically in FIG. 3 by a process line which, drawn in on the left from the bottom, guides adsorber resin 302 preladen with coffee constituents upward to the adsorber resin 303 laden with coffee constituents and caffeine.

Step 404 preferably comprises one or more of the following measures:
treating the adsorber resin with liquid water or an aqueous solution, preferably at a water temperature of at least 70° C., more preferably of at least 85° C., so as to remove DCM from the adsorber resin, preferably from pores of the adsorber resin,
treating the adsorber resin with steam, so as to remove DCM from the adsorber resin, preferably from pores of the adsorber resin,
for regenerating the loadability of the adsorber resin with caffeine, treating the adsorber resin with an aqueous alkaline solution, preferably a sodium hydroxide-containing aqueous solution.

The process shown in FIG. 3 is illustrative of the inventive use of a suitable adsorber resin as a kind of “intermediate caffeine storage medium” with the two-stage extraction sequence, which has been newly developed in the context of the present invention and is technically advantageous, for removal and recovery of caffeine from an aqueous extraction liquid: “liquid-solid” (loading step; process step 402; caffeine-enriched aqueous extraction liquid/adsorber resin) plus “solid-liquid” (unloading step; process step 403; laden adsorber resin/DCM).

The process shown in FIG. 3 is additionally illustrative of the fact that the (selective) desorption of caffeine bound to adsorber resin by means of dichloromethane results in freeing or unloading of caffeine from the adsorber resin, hence allowing it to be reused for the adsorption of caffeine (efficient circulation process). The adsorber resin can thus be reused (and repeatedly) to (selectively) bind caffeine from an aqueous extraction liquid and then to release it (selectively) to dichloromethane. The process of the invention thus enables efficient production of high-quality decaffeinated green coffee beans with exploitation of the adsorption and desorption properties of the adsorber resin.

### EXAMPLES

### Example Experiment 1 for Steps S2 and S3 of the Process of the Invention

Contacting of a caffeine-enriched aqueous extraction liquid with an adsorber resin or with another adsorption material, followed by contacting of the resulting caffeine-laden adsorber resin or the resulting other adsorption material with dichloromethane.

The following adsorber resins and other adsorption materials were used:
[1] microporous activated carbon-like adsorber composed of spherical particles of a pyrolyzed styrene-DVB copolymer (LEWATIT® AF 5 from Lanxess)
[2] macroporous, monodisperse, highly acidic cation exchange resin in food quality, based on a styrene-divinylbenzene copolymer (LEWATIT® S 2568 H from Lanxess)
[3] macroporous adsorber resin without a functional group, based on a divinylbenzene-crosslinked polystyrene (LEWATIT® VP OC 1064 MD PH from Lanxess)
[4] porous activated carbon (ColorSorb™ W7 series from Jacobi)

The selection of the adsorber materials in this example is merely illustrative, and other adsorber materials may also be used by the person skilled in the art, mutatis mutandis.

Example experiment 1 conducted here illustrates the identification and selection of a particularly suitable adsorption material (namely adsorber resin) for performance of a process of the invention for production of decaffeinated green coffee beans, wherein the adsorber resin is used in steps S2 and S3 of the process of the invention. Unless stated otherwise, the experimental procedure was identical in each case.

Loading (Adsorption) of Adsorber Resins and Other Adsorption Materials with Caffeine from An Aqueous Solution:

In example experiment 1, various adsorber resins or other adsorption materials were weighed out on a stirrer plate and mixed with caffeine, in a mass ratio of 7.5:1 (15 g of the respective adsorber resin or of the respective other adsorption material per 2 g of caffeine). Water was added to this mixture, so as to result in a mixture of a caffeinated aqueous extraction liquid with an adsorber resin or with another adsorption material. This mixture was stirred, and then the aqueous solution was filtered off. The aqueous solution (filtered off) was analyzed by HPLC-UV according to or analogously to DIN ISO 20481, and so it was possible to make a conclusion as to the adsorption capacity of the adsorber. In this way, the adsorption performance (=caffeine adsorption rate: mass of caffeine adsorbed per unit volume of adsorber resin or other adsorption material) of the materials used was determined.

Leaching (Desorption) of Caffeine from the Caffeine-Laden Adsorber Resins or from the Caffeine-Laden Adsorption Materials:

Subsequently, about 200 g of dichloromethane (DCM) was added to the previously caffeine-laden adsorber resins or other adsorption materials. The dichloromethane was filtered off, and the caffeine content of the dichloromethane solution was analyzed by HPLC-UV according to or analogously to DIN ISO 20481. In this way, it was possible to determine a DCM-caffeine unloading capacity (amount of caffeine desorbed by DCM in percent) for the materials used.

Analogously, the adsorber resins or other adsorption materials that had previously been laden with caffeine were rinsed with water at a temperature of 80° C. The water was filtered off, and the caffeine content of the aqueous solution was analyzed. In this way, it was possible to determine a caffeine desorption rate (amount of caffeine desorbed by water at a temperature of 80° C. in %) of the materials used.

Table 1 shows the results of example experiment 1.

TABLE 1

| Adsorber | | | | Caffeine desorption | | | |
|---|---|---|---|---|---|---|---|
| resin or | Caffeine adsorption | | | | Caffeine | | |
| adsorption | Caffeine | Caffeine | Caffeine | | in adsorber | Desorbed | Caffeine |
| material | adsorbed | reduction | adsorption | | beforehand | caffeine | desorption |
| used | [g] | rate [%] | rate [%] | Solvent | [g] | [g] | rate [%] |
| [1] | 2.00 | 100 | 13 | DCM | 1.8 | 0.8 | 44 |
| [2] | 1.05 | 53 | 7 | DCM | 1.1 | 0.6 | 57 |
| [3] | 1.06 | 54 | 8 | DCM | 1.1 | 1.1 | 100 |
| [4] | 2.00 | 100 | 13 | DCM | 1.7 | 0.7 | 43 |
| [1] | 2.00 | 100 | 13 | 80° C, | 2.0 | 0.0 | 0 |
| | | | | H2O | | | |
| [2] | 0.98 | 52 | 7 | 80° C, | 1.1 | 0.5 | 44 |
| | | | | H2O | | | |
| [3] | 1.180 | 59 | 8 | 80° C, | 1.16 | 0.37 | 32 |
| | | | | H2O | | | |
| [4] | 2.00 | 100 | 13 | 80° C, | 1.89 | 0.00 | 0.0 |
| | | | | H2O | | | |

The macroporous adsorber resins [2] and [3] used have the advantageous property of desorbing a large amount of caffeine on contacting of a previously caffeine-laden adsorber resin with dichloromethane such that caffeine is dissolved in the dichloromethane. This is apparent from the DCM-caffeine unloading capacity (amount of caffeine desorbed by DCM; Desorbed caffeine [%] in table 1), which is 57% for adsorber resin [2] and 100% for adsorber resin [3].

The macroporous adsorber resins [2] and [3] used additionally bind a sufficiently large amount of caffeine from a caffeine-enriched aqueous extraction liquid. This is apparent from the percentage loading of the adsorber resins with the caffeine used (Adsorbed caffeine [%] in table 1), which is 53% for adsorber resin [2] and 54% for adsorber resin [3]. The adsorption performance (=caffeine loading capacity: mass of caffeine adsorbed per unit mass of adsorber resin or other adsorption material) was found to be 7% for adsorber resin [2] and 8% for adsorber resin [3]. Although these values are lower than for comparative materials [1] and [4], the primary crucial factor is the above-discussed DCM-caffeine unloading capacity.

Treatment with water did not achieve good caffeine unloading capacity; treatment with water is additionally not selective.

It has thus been found that the use of a macroporous adsorber resin selected from the group consisting of polystyrene, polydivinylbenzene and copolymers thereof with one another and with other monomers (the adsorber resins [2] and [3] used) is particularly advantageous in order to:
i) bind caffeine from a caffeine-enriched aqueous extraction liquid and
ii) desorb caffeine on contact of a previously caffeine-laden adsorber resin with dichloromethane such that caffeine is dissolved in the dichloromethane.

It has additionally been found that the use of a macroporous adsorber resin which is a nonfunctionalized, nonionic and divinylbenzene-crosslinked polystyrene (the adsorber resin [3] used) is very particularly advantageous in order to desorb caffeine on contacting of a previously caffeine-laden adsorber resin with dichloromethane such that caffeine is dissolved in the dichloromethane; cf. the DCM-caffeine unloading capacity of 100% for adsorber resin [3].

It has also been found that dichloromethane is of particularly good suitability for desorbing caffeine from a previously caffeine-laden adsorber resin. This is a major advantage of the process of the invention, especially of step S3, over processes known from the prior art (cf. DE 2600492 A1 and DE 2832267 A1 inter alia).

The use of water at a temperature of 80° C., by contrast, showed significantly poorer performance.

### Example Experiment 2: Adsorption of Caffeine on an Adsorber Resin by Contacting of a Caffeine-Enriched Aqueous Extraction Liquid with an Adsorber Resin

The following adsorber resins were used:
[1] macroporous adsorber resin without a functional group, nonionic, based on a divinylbenzene-crosslinked polystyrene (Purolite® XFP2700)
[2] macroporous adsorber resin without a functional group, nonionic, based on polydivinylbenzene (PuroSorb™ PAD500 from Purolite)
[3] macroporous adsorber resin without a functional group, nonionic, based on a divinylbenzene-crosslinked polystyrene (LEWATIT® VP OC 1064 MD PH from Lanxess)
[4] macroporous adsorber resin without a functional group, nonionic, based on a divinylbenzene-crosslinked polystyrene (Macronet™ MN202 from Purolite)
[5] macroporous adsorber resin without a functional group, nonionic, based on polydivinylbenzene (PuroSorb™ PAD600 from Purolite)
[6] macroporous adsorber resin functionalized with tertiary amino groups, basic, based on a divinylbenzene-crosslinked polystyrene (Macronet™ MN102 from Purolite)
[7] macroporous adsorber resin functionalized with tertiary amino groups, basic, based on a divinylbenzene-crosslinked polystyrene (Macronet™ MN150 from Purolite)
[8] macroporous adsorber resin functionalized with sulfonic acid groups, acidic, based on a divinylbenzene-crosslinked polystyrene (Purolite® C160H from Purolite)
[9] macroporous adsorber resin functionalized with sulfonic acid groups, acidic, based on a divinylbenzene-crosslinked polystyrene (Macronet™ MN502 from Purolite)

The selection of the adsorber resins in this example experiment 2 is merely illustrative, and other adsorber resins can also be examined analogously by the person skilled in the art.

In example experiment 2, different adsorber resins were analyzed with regard to their caffeine adsorption performance. Unless stated otherwise, the experimental procedure was identical in each case. A caffeine-enriched aqueous extraction liquid having a caffeine concentration of 1500 mg/L was produced. 40 g of this caffeine-enriched aqueous extraction liquid was blended with 1 g or 5 g of the respective adsorber resin, and the resulting mixture of adsorber resin and caffeine-enriched aqueous extraction liquid was incubated for one hour in each case. The caffeine content of the aqueous extraction liquid was analyzed by HPLC-UV according to or analogously to DIN ISO 20481 after an incubation time of one hour. This was then used to calculate corresponding caffeine reduction rates (reduced amount of caffeine after an incubation time of one hour of the aqueous extraction liquid with the respective adsorber resin in %) and caffeine adsorption rates (adsorbed mass of caffeine per unit mass of adsorber resin used in %).

Table 2 shows the results for the decrease in the caffeine content in the aqueous extraction liquid when different adsorber resins are used (caffeine reduction rates).

Table 3 shows the results for the uptake of caffeine from the aqueous extraction liquid when different adsorber resins are used (caffeine adsorption rates).

TABLE 2

| | Caffeine content in aqueous | | | |
|---|---|---|---|---|
| | extraction liquid after | | Caffeine reduction rate after | |
| | incubation time of 1 h [mg/L] | | incubation time of 1 h [%] | |
| | 1 g of | 5 g of | 1 g of | 5 g of |
| Adsorber | adsorber | adsorber | adsorber | adsorber |
| resin | resin used | resin used | resin used | resin used |
| [1] | 779 | 175 | 48.7 | 88.5 |
| [2] | 849 | 264 | 44.1 | 82.6 |
| [3] | 1001 | 408 | 34.1 | 73.1 |
| [4] | 1077 | 542 | 29.1 | 64.3 |
| [5] | 1088 | 591 | 28.4 | 61.1 |
| [6] | 1123 | 845 | 26.1 | 44.4 |
| [7] | 1127 | 797 | 25.8 | 47.5 |
| [8] | 1179 | 715 | 22.4 | 52.9 |
| [9] | 1202 | 807 | 20.9 | 46.9 |

TABLE 3

| | Amount of caffeine adsorbed | | Caffeine adsorption rate | |
|---|---|---|---|---|
| | after incubation time of 1 | | after incubation time of | |
| | h [mg/g] | | 1 h [%] | |
| | 1 g of | 5 g of | 1 g of | 5 g of |
| Adsorber | adsorber | adsorber | adsorber | adsorber |
| resin | resin used | resin used | resin used | resin used |
| [1] | 29.6 | 10.8 | 2.96 | 1.08 |
| [2] | 26.8 | 10.0 | 2.68 | 1.00 |
| [3] | 20.7 | 8.9 | 2.07 | 0.89 |
| [4] | 17.7 | 7.8 | 1.77 | 0.78 |
| [5] | 17.2 | 7.4 | 1.72 | 0.74 |
| [6] | 15.8 | 5.4 | 1.58 | 0.54 |
| [7] | 15.7 | 5.8 | 1.57 | 0.58 |
| [8] | 13.6 | 6.4 | 1.36 | 0.64 |
| [9] | 12.7 | 5.7 | 1.27 | 0.57 |

All the macroporous adsorber resins [1] to [9] used here are capable of binding an amount of caffeine from a caffeine-enriched aqueous extraction liquid (as per step S2 of the process of the invention).

In this case, the caffeine content of a caffeinated aqueous extraction liquid is distinctly lowered. The caffeine reduction rates (reduced amount of caffeine after one hour of incubation time of the aqueous extraction liquid with the respective adsorber resin in %) are in the range between 20.9% and 48.7% (using 1 g of adsorber resin in each case) or in the range between 44.4% and 88.5% (using 5 g of adsorber resin in each case).

All the macroporous adsorber resins [1] to [9] used here are correspondingly capable of adsorbing an amount of caffeine (as per step S2 of the process of the invention). The caffeine adsorption rates (adsorbed mass of caffeine per unit mass of adsorber resin used in %) are in the range between 1.27% and 2.96% (using 1 g of adsorber resin in each case) or in the range between 0.54% and 1.08% (using 5 g of adsorber resin in each case).

It has additionally been found that the use of a macroporous adsorber resin which is selected from the group consisting of polystyrene, polydivinylbenzene and copolymers thereof with one another and with other monomers and which is nonfunctionalized and nonionic is very particularly advantageous in order to bind caffeine from the extraction liquid to the adsorber resin on contacting with a caffeine-enriched aqueous extraction liquid (cf. the respectively particularly good caffeine reduction rates and caffeine adsorption rates for adsorber resins [1] to [5]).

### Example Experiment 3: Adsorption of Caffeine on an Adsorber Resin by (Continuous) Passage of a Caffeine-Enriched Aqueous Extraction Liquid Through an Adsorber Resin-Filled Adsorber Column

In example experiment 3, in each case, a “coextract caffeine solution” (a caffeine-enriched aqueous extraction liquid; caffeine concentration: see the table headings below) was passed through an adsorber column having a capacity of 100 mL (100 mL=one bed volume, BV), where the adsorber column was filled with an adsorber resin in each case. A caffeinated aqueous extraction liquid thus flowed through the adsorber resin. In each case after passage of in each case 2.5 BV or 5 BV (=passage of 250 mL or 500 mL) of the coextract caffeine solution through the adsorber column, a sample of the eluted coextract caffeine solution was taken and the caffeine content of the respective sample was analyzed according to or analogously to DIN ISO 20481. It was then possible to use this to draw conclusions as to the
i) amount of eluted (unadsorbed) caffeine,
ii) amount of caffeine adsorbed on the adsorber resin per pass of in each case 2.5 BV or of 5 BV,
iii) cumulative amount of caffeine adsorbed on the adsorber resin,
iv) caffeine loading of the adsorber resin in g/L (mass of caffeine adsorbed per unit volume of adsorber resin in g/L), and
v) caffeine loading of the adsorber resin in mol/l (amount of caffeine adsorbed per unit volume of adsorber resin in mol/l)

The following adsorber resins were used:
[1] macroporous adsorber resin without a functional group, nonionic, based on a divinylbenzene-crosslinked polystyrene (LEWATIT® VP OC 1064 MD PH from Lanxess)
[2] microporous activated carbon-like adsorber composed of spherical particles of a pyrolyzed styrene-DVB copolymer (LEWATIT® AF 5 from Lanxess)
[3] macroporous, monodisperse, highly acidic cation exchange resin in food quality, based on a styrene-divinylbenzene copolymer (LEWATIT® S 2568 H from Lanxess)
[4] macroporous, monodisperse, highly acidic cation exchange resin in food quality, based on a styrene-divinylbenzene copolymer (LEWATIT® S 2568, Na⁺ supply form, from Lanxess)
[5] macroporous adsorber resin without a functional group, nonionic, based on a divinylbenzene-crosslinked polystyrene (Macronet™ MN270 from Purolite)

The selection of the adsorber resins in this example experiment 3 is merely illustrative, and other adsorber resins can also be examined analogously by the person skilled in the art.

Tables 4 to 8 show the respective results from example experiment 3 with use of adsorber resins [1] to [5].

TABLE 4
Passage of a coextract caffeine solution (caffeine concentration: 642 mg/L)
through an adsorber column filled with adsorber resin [1] (volume of the column = 100 mL =
1 BV)

| | | | | Cumulative | | |
|---|---|---|---|---|---|---|
| | | | Adsorbed | amount | | |
| | Caffeine | | caffeine | of | | |
| BV | content | Amount | per pass | caffeine | Caffeine | Caffeine |
| (1 | of the eluted | of | of the | adsorbed | loading | loading |
| BV = | coextract | eluted | respective | on the | of | of |
| 100 | caffeine solution | (unadsorbed) | BV | adsorber resin | the adsorber | the adsorber |
| mL) | [mg/L] | caffeine [mg] | [g] | [g] | resin [g/L] | resin [mol/L] |
| 0 | 0 | 0 | 0.000 | 0.000 | 0.000 | 0.000 |
| 5 | 0 | 321 | 0.321 | 0.321 | 3.210 | 0.017 |
| 10 | 0 | 642 | 0.321 | 0.642 | 6.420 | 0.033 |
| 15 | 0 | 963 | 0.321 | 0.963 | 9.630 | 0.050 |
| 20 | 0 | 1284 | 0.321 | 1.284 | 12.840 | 0.066 |
| 25 | 1.9 | 1605 | 0.321 | 1.605 | 16.045 | 0.083 |
| 30 | 31.9 | 1926 | 0.313 | 1.917 | 19.171 | 0.099 |
| 35 | 325 | 2247 | 0.232 | 2.149 | 21.489 | 0.111 |
| 40 | 650 | 2568 | 0.077 | 2.226 | 22.261 | 0.115 |
| 45 | 723 | 2889 | 0.000 | 2.226 | 22.261 | 0.115 |
| 50 | 752 | 3210 | 0.000 | 2.226 | 22.261 | 0.115 |

TABLE 5
Passage of a coextract caffeine solution (caffeine concentration: 700 mg/L)
through an adsorber column filled with adsorber resin [2] (volume of the column = 100 ml =
1 BV)

| | | | | Cumulative | | |
|---|---|---|---|---|---|---|
| | | | Adsorbed | amount | | |
| | Caffeine | | caffeine | of | | |
| BV | content | Amount | per pass | caffeine | Caffeine | Caffeine |
| (1 | of the eluted | of | of the | adsorbed | loading | loading |
| BV = | coextract | eluted | respective | on the | of | of |
| 100 | caffeine solution | (unadsorbed) | BV | adsorber resin | the adsorber | the adsorber |
| mL) | [mg/L] | caffeine [mg] | [g] | [g] | resin [g/L] | resin [mol/L] |
| 0 | 0 | 0 | 0.000 | 0.000 | 0.000 | 0.000 |
| 2.5 | 1.3 | 175 | 0.175 | 0.175 | 1.748 | 0.009 |
| 5 | 36.4 | 350 | 0.170 | 0.345 | 3.451 | 0.018 |
| 7.5 | 158 | 525 | 0.151 | 0.496 | 4.958 | 0.026 |
| 10 | 276 | 700 | 0.121 | 0.617 | 6.166 | 0.032 |
| 12.5 | 343 | 875 | 0.098 | 0.714 | 7.142 | 0.037 |
| 15 | 379 | 1050 | 0.085 | 0.799 | 7.990 | 0.041 |
| 17.5 | 411 | 1225 | 0.076 | 0.875 | 8.752 | 0.045 |
| 20 | 425 | 1400 | 0.071 | 0.946 | 9.457 | 0.049 |
| 25 | 464 | 1750 | 0.128 | 1.073 | 10.735 | 0.055 |
| 30 | 475 | 2100 | 0.115 | 1.189 | 11.887 | 0.061 |
| 35 | 502 | 2450 | 0.106 | 1.294 | 12.945 | 0.067 |
| 40 | 529 | 2800 | 0.092 | 1.387 | 13.867 | 0.071 |
| 45 | 429 | 3150 | 0.111 | 1.497 | 14.972 | 0.077 |
| 50 | 565 | 3500 | 0.102 | 1.599 | 15.987 | 0.082 |

TABLE 6
Passage of a coextract caffeine solution (caffeine concentration: 2087 mg/L)
through an adsorber column filled with adsorber resin [3] (volume of the column = 100 mL =
1 BV)

| | | | | Cumulative | | |
|---|---|---|---|---|---|---|
| | | | Adsorbed | amount | | |
| | Caffeine | | caffeine | of | | |
| BV | content | Amount | per pass | caffeine | Caffeine | Caffeine |
| (1 | of the eluted | of | of the | adsorbed | loading | loading |
| BV = | coextract | eluted | respective | on the | of | of |
| 100 | caffeine solution | (unadsorbed) | BV | adsorber resin | the adsorber | the adsorber |
| mL) | [mg/L] | caffeine [mg] | [g] | [g] | resin [g/L] | resin [mol/L] |
| 0 | 0 | 0 | 0.000 | 0.000 | 0.000 | 0.000 |
| 2.5 | 0 | 521.75 | 0.522 | 0.522 | 5.218 | 0.027 |
| 5 | 0 | 1043.5 | 0.522 | 1.044 | 10.435 | 0.054 |
| 7.5 | 477 | 1565.25 | 0.462 | 1.506 | 15.056 | 0.078 |
| 10 | 5990 | 2087 | −0.287 | 1.219 | 12.190 | 0.063 |
| 12.5 | 5117 | 2608.75 | −0.867 | 0.352 | 3.524 | 0.018 |
| 15 | 2474 | 3130.5 | −0.427 | 0 | 0 | 0 |
| 17.5 | 2705 | 3652.25 | −0.126 | 0 | 0 | 0 |
| 20 | 2708 | 4174 | −0.155 | 0 | 0 | 0 |
| 25 | 2585 | 5217.5 | −0.280 | 0 | 0 | 0 |
| 30 | 1647 | 6261 | − 0.015 | 0 | 0 | 0 |
| 35 | 1627 | 7304.5 | 0.225 | 0.225 | 2.250 | 0.012 |
| 40 | 1627 | 8348 | 0.230 | 0.455 | 4.550 | 0.023 |
| 45 | 1641 | 9391.5 | 0.227 | 0.682 | 6.815 | 0.035 |
| 50 | 1646 | 10435 | 0.222 | 0.903 | 9.033 | 0.047 |

TABLE 7
Passage of a coextract caffeine solution (caffeine concentration: 2820 mg/L)
through an adsorber column filled with adsorber resin [4] (volume of the column = 100 ml =
1 BV)

| | | | | Cumulative | | |
|---|---|---|---|---|---|---|
| | | | Adsorbed | amount | | |
| | Caffeine | | caffeine | of | | |
| BV | content | Amount | per pass | caffeine | Caffeine | Caffeine |
| (1 | of the eluted | of | of the | adsorbed | loading | loading |
| BV = | coextract | eluted | respective | on the | of | of |
| 100 | caffeine solution | (unadsorbed) | BV | adsorber resin | the adsorber | the adsorber |
| mL) | [mg/L] | caffeine [mg] | [g] | [g] | resin [g/L] | resin [mol/L] |
| 0 | 0 | 0 | 0.000 | 0.000 | 0.000 | 0.000 |
| 2.5 | 2230 | 705 | 0.426 | 0.426 | 4.263 | 0.022 |
| 5 | 2590 | 1410 | 0.103 | 0.529 | 5.288 | 0.027 |
| 7.5 | 2670 | 2115 | 0.048 | 0.576 | 5.763 | 0.030 |
| 10 | 2670 | 2820 | 0.038 | 0.614 | 6.138 | 0.032 |
| 12.5 | 2830 | 3525 | 0.018 | 0.631 | 6.313 | 0.033 |
| 15 | 1970 | 4230 | 0.105 | 0.736 | 7.363 | 0.038 |
| 17.5 | 2390 | 4935 | 0.160 | 0.896 | 8.963 | 0.046 |
| 20 | 2630 | 5640 | 0.078 | 0.974 | 9.738 | 0.050 |
| 25 | 2720 | 7050 | 0.073 | 1.046 | 10.463 | 0.054 |
| 30 | 2770 | 8460 | 0.038 | 1.084 | 10.838 | 0.056 |
| 35 | 2780 | 9870 | 0.023 | 1.106 | 11.063 | 0.057 |
| 40 | 2640 | 11280 | 0.055 | 1.161 | 11.613 | 0.060 |
| 45 | 2820 | 12690 | 0.045 | 1.206 | 12.063 | 0.062 |
| 50 | 2760 | 14100 | 0.015 | 1.221 | 12.213 | 0.063 |

TABLE 8
Passage of a coextract caffeine solution (caffeine concentration: 642 mg/L)
through an adsorber column filled with adsorber resin [5] (volume of the column = 100 ml =
1 BV)

| | | | | Cumulative | | |
|---|---|---|---|---|---|---|
| | | | Adsorbed | amount | | |
| | Caffeine | | caffeine | of | | |
| BV | content | Amount | per pass | caffeine | Caffeine | Caffeine |
| (1 | of the eluted | of | of the | adsorbed | loading | loading |
| BV = | coextract | eluted | respective | on the | of | of |
| 100 | caffeine solution | (unadsorbed) | BV | adsorber resin | the adsorber | the adsorber |
| mL) | [mg/L] | caffeine [mg] | [g] | [g] | resin [g/L] | resin [mol/L] |
| 0 | 0 | 0 | 0.000 | 0.000 | 0.000 | 0.000 |
| 5 | 14.2 | 321 | 0.317 | 0.317 | 3.175 | 0.016 |
| 10 | 19 | 642 | 0.313 | 0.630 | 6.302 | 0.032 |
| 15 | 45 | 963 | 0.305 | 0.935 | 9.352 | 0.048 |
| 20 | 171 | 1284 | 0.267 | 1.202 | 12.022 | 0.062 |
| 25 | 101 | 1605 | 0.253 | 1.455 | 14.552 | 0.075 |
| 30 | 143 | 1926 | 0.260 | 1.715 | 17.152 | 0.088 |
| 35 | 197 | 2247 | 0.236 | 1.951 | 19.512 | 0.100 |
| 40 | 230 | 2568 | 0.214 | 2.165 | 21.654 | 0.112 |
| 45 | 263 | 2889 | 0.198 | 2.363 | 23.632 | 0.122 |
| 50 | 292 | 3210 | 0.182 | 2.545 | 25.454 | 0.131 |

All the macroporous adsorber resins [1] to [5] used here are capable of binding an amount of caffeine from a caffeine-enriched aqueous coextraction liquid (as per step S2 of the process of the invention). It has additionally been found that contacting (as per step S2 of the process of the invention) comprising flow of a caffeine-enriched aqueous extraction liquid over an adsorber resin in a defined first flow direction is particularly advantageous.

It has additionally been found that the use of a macroporous adsorber resin which is selected from the group consisting of polystyrene, polydivinylbenzene and copolymers thereof with one another and with other monomers, and which is nonfunctionalized and nonionic (adsorber resins [1] and [5] used), is very particularly advantageous in order to bind caffeine from the extraction liquid to the adsorber resin on repeated contacting or on contacting by means of flow of a caffeine-enriched aqueous extraction liquid. This is shown by the high maximum caffeine loading of 22.261 g/L in the case of adsorber resin [1] and of 25.454 g/L in the case of adsorber resin [5] (each attained after passage of 40 BV or 50 BV) and by the cumulative amount of the caffeine adsorbed on the adsorber resin of 2.226 g when 100 mL of adsorber resin [1] is used and of 2.545 g when 100 mL of adsorber resin [5] is used (each attained after passage of 40 BV or 50 BV).

It is additionally clear from example experiment 3 that, at the start of passage of the coextract caffeine solution through the adsorber resins, a large amount of caffeine is bound to the adsorber resin, while the caffeine is in some cases removed completely from the aqueous solution (cf. the starting values of adsorbed caffeine per pass of the respective BV in column 4 of tables 4 to 8). This partly or fully decaffeinated aqueous solution (caffeine-depleted aqueous extraction liquid) that arises after contacting with the respective adsorber resin can thus be reused as aqueous extraction liquid in a step S1 of the process of the invention (advantageous circulation process).

Depending on the nature of the adsorber resin used, however, saturation (caffeine uptake capacity limit) of the adsorber resin sets in over and above a certain amount of bound caffeine. This becomes clear, inter alia, by an increase in the caffeine content of the eluted coextract caffeine solution. Thus, in example experiment 3 conducted here, when 100 ml of adsorber resin [1] is used, the caffeine uptake capacity limit is attained roughly on passage of 35 BV of the coextract caffeine solution, since barely any further caffeine, or none at all, is bound to the adsorber resin from this juncture, but rather remains in the eluted coextract caffeine solution.

This shows that: Preferably, in a process of the invention, on attainment of saturation, the process moves from step S2 (loading of the adsorber resin with caffeine) to step S3 (unloading by contacting with DCM). This is because a predetermined loading of the adsorber resin with caffeine has been attained at least on saturation with caffeine.

### Example Experiment 4: Repeated Adsorption of Caffeine on an Adsorber Resin by Passage of a Caffeine-Enriched Aqueous Extraction Liquid Through an Adsorber Resin-Filled Adsorber Column in Two Loading Cycles (Two Separate Adsorption Steps) with an Intervening Caffeine Desorption Step

In example experiment 4, an adsorber column having a capacity per adsorber column of 100 mL was filled in each case with an adsorber resin. A coextract caffeine solution (a caffeine-enriched aqueous extraction liquid having a caffeine concentration of 4500 mg/L) was passed through these adsorber resin-filled adsorber columns (cycle 1). The volume flow rate of the coextract caffeine solution passed through was 5 BV/h. After passage of in each case 2.5 BV or 5 BV of the coextract caffeine solution through the adsorber column, a sample of the eluted coextract caffeine solution was taken and the caffeine content of the sample was analyzed.

After the first loading cycle had ended, the caffeine-laden adsorber columns were rinsed with dichloromethane in order to desorb caffeine from the adsorber columns. The caffeine content in the resulting dichloromethane solution was determined, and this was used to calculate the recovery of caffeine.

Subsequently, the loading cycle was repeated as described above (cycle 2). In the second loading cycle too, after passage of in each case 2.5 BV or 5 BV of the coextract caffeine solution through the adsorber column, a sample of the eluted coextract caffeine solution was taken and the caffeine content of the sample was analyzed. It was then possible to use this to draw conclusions as to the
i) amount of caffeine adsorbed on the adsorber resin per pass of in each case 2.5 BV or of 5 BV,
ii) cumulative amount of caffeine adsorbed on the adsorber resin,
iii) caffeine loading of the adsorber resin (mass of caffeine adsorbed per unit volume of adsorber resin in g/L), and
iv) recovery of caffeine.

The following adsorber resins were used:
[1] macroporous adsorber resin without a functional group, nonionic, based on a divinylbenzene-crosslinked polystyrene (LEWATIT® VP OC 1064 MD PH from Lanxess)
[2] macroporous adsorber resin without a functional group, nonionic, based on polydivinylbenzene (PuroSorb™ PAD600FM from Purolite)
[3] macroporous adsorber resin without a functional group, nonionic, based on polydivinylbenzene (PuroSorb™ PAD500 from Purolite)

The selection of the adsorber resins in this example is merely illustrative, and other adsorber resins may also be used.

Tables 9 to 11 show the respective results from example experiment 4 with use of adsorber resins [1] to [3].

TABLE 9
Results of example experiment 4 using adsorber resin [1]

| | | | | | | Cumulative | |
|---|---|---|---|---|---|---|---|
| | | | | | Adsorbed | amount of | |
| | | | Caffeine | | caffeine | caffeine | Caffeine |
| | | | content | | per pass | adsorbed | loading |
| | | | of the eluted | Volume | of the | on the | of the |
| | Experiment | | coextract caffeine | flow | respective | adsorber | adsorber |
| | time | BV | solution | rate | BV | resin | resin |
| | [h] | eluted | [mg/L] | [BV/h] | [g] | [g] | [g/L] |
| Cycle 1 | 0 | 0.00 | 0 | 5.00 | 0.00 | 0.00 | 0.00 |
| | 0.5 | 2.49 | 0 | 4.95 | 1.12 | 1.12 | 11.20 |
| | 1 | 4.97 | 131 | 4.99 | 1.10 | 2.22 | 22.22 |
| | 1.5 | 7.61 | 1180 | 5.16 | 0.98 | 3.20 | 31.98 |
| | 2 | 10.11 | 3400 | 4.95 | 0.56 | 3.76 | 37.57 |
| | 2.5 | 12.38 | 4490 | 4.95 | 0.14 | 3.89 | 38.94 |
| | 3 | 13.10 | 4770 | 3.78 | −0.03 | 3.87 | 38.66 |
| | 3.5 | 15.41 | 5130 | 5.03 | −0.10 | 3.77 | 37.67 |

Recovery of caffeine after cycle 1: 93.6%

| | | | | | | | |
|---|---|---|---|---|---|---|---|
| Cycle 2 | 0 | 0 | 0 | 5.14 | 0.00 | 0.00 | 0.00 |
| | 0.5 | 2.55 | 260 | 5.07 | 1.11 | 1.11 | 11.15 |
| | 1 | 5.01 | 1280 | 4.94 | 0.93 | 2.05 | 20.49 |
| | 1.5 | 7.46 | 2320 | 5.00 | 0.67 | 2.72 | 27.20 |
| | 2 | 9.67 | 3130 | 4.67 | 0.43 | 3.15 | 31.49 |
| | 2.5 | 13.34 | 3750 | 6.00 | 0.28 | 3.43 | 34.31 |
| | 3 | 16.04 | 3890 | 4.69 | 0.18 | 3.61 | 36.13 |
| | 3.5 | 16.49 | 4190 | 4.74 | 0.11 | 3.72 | 37.22 |

Recovery of caffeine after cycle 2: 82.4%

TABLE 10
Results of example experiment 4 using adsorber resin [2]

| | | | | | | Cumulative | |
|---|---|---|---|---|---|---|---|
| | | | | | Adsorbed | amount of | |
| | | | Caffeine | | caffeine | caffeine | Caffeine |
| | | | content | | per pass | adsorbed | loading |
| | | | of the eluted | Volume | of the | on the | of the |
| | Experiment | | coextract caffeine | flow | respective | adsorber | adsorber |
| | time | BV | solution | rate | BV | resin | resin |
| | [h] | eluted | [mg/L] | [BV/h] | [g] | [g] | [g/L] |
| Cycle 1 | 0 | 0.00 | 0 | 4.95 | 0.00 | 0.00 | 0.00 |
| | 0.5 | 2.49 | 0 | 5.02 | 1.12 | 1.12 | 11.21 |
| | 1 | 4.93 | 18 | 4.84 | 1.11 | 2.23 | 22.28 |
| | 1.5 | 7.28 | 141 | 4.87 | 1.07 | 3.30 | 33.01 |
| | 2 | 9.85 | 2140 | 4.98 | 0.83 | 4.13 | 41.28 |
| | 2.5 | 12.52 | 4270 | 5.03 | 0.32 | 4.45 | 44.52 |
| | 3 | 15.50 | 4380 | 5.30 | 0.05 | 4.50 | 44.97 |
| | 3.5 | 18.01 | 5240 | 4.99 | −0.08 | 4.42 | 44.18 |

Recovery of caffeine after cycle 1: 100%

| | | | | | | | |
|---|---|---|---|---|---|---|---|
| Cycle 2 | 0 | 0.00 | 0 | 4.99 | 0.00 | 0.00 | 0.00 |
| | 0.5 | 2.47 | 38 | 4.90 | 1.11 | 1.11 | 11.08 |
| | 1 | 5.02 | 260 | 5.14 | 1.09 | 2.20 | 22.01 |
| | 1.5 | 7.56 | 1350 | 4.94 | 0.93 | 3.13 | 31.32 |
| | 2 | 10.22 | 1640 | 5.28 | 0.77 | 3.90 | 38.99 |
| | 2.5 | 12.44 | 3200 | 4.68 | 0.52 | 4.42 | 44.17 |
| | 3 | 14.14 | 4080 | 4.74 | 0.20 | 4.62 | 46.20 |
| | 3.5 | 16.86 | 3820 | 4.89 | 0.13 | 4.75 | 47.52 |

Recovery of caffeine after cycle 2: 84.7%

TABLE 11
Results of example experiment 4 using adsorber resin [3]

| | | | | | | Cumulative | |
|---|---|---|---|---|---|---|---|
| | | | | | Adsorbed | amount of | |
| | | | Caffeine | | caffeine | caffeine | Caffeine |
| | | | content | | per pass | adsorbed | loading |
| | | | of the eluted | Volume | of the | on the | of the |
| | Experiment | | coextract caffeine | flow | respective | adsorber | adsorber |
| | time | BV | solution | rate | BV | resin | resin |
| | [h] | eluted | [mg/L] | [BV/h] | [g] | [g] | [g/L] |
| Cycle 1 | 0 | 0.00 | 0 | 4.99 | 0.00 | 0.00 | 0.00 |
| | 0.5 | 2.52 | 0 | 5.11 | 1.14 | 1.14 | 11.36 |
| | 1 | 5.00 | 22 | 4.90 | 1.12 | 2.26 | 22.58 |
| | 1.5 | 7.24 | 426 | 4.76 | 1.03 | 3.29 | 32.90 |
| | 2 | 9.98 | 2930 | 5.22 | 0.70 | 3.99 | 39.94 |
| | 2.5 | 12.73 | 4220 | 4.97 | 0.24 | 4.23 | 42.30 |
| | 3 | 14.74 | 5005 | 4.86 | −0.03 | 4.20 | 42.02 |
| | 3.5 | 17.19 | 4890 | 4.96 | −0.11 | 4.09 | 40.92 |

Recovery of caffeine after cycle 1: 100%

| | | | | | | | |
|---|---|---|---|---|---|---|---|
| Cycle 2 | 0 | 0.00 | 0 | 4.97 | 0.00 | 0.00 | 0.00 |
| | 0.5 | 2.52 | 39 | 5.10 | 1.13 | 1.13 | 11.28 |
| | 1 | 5.08 | 504 | 5.06 | 1.07 | 2.20 | 22.02 |
| | 1.5 | 7.52 | 1730 | 4.97 | 0.85 | 3.05 | 30.49 |
| | 2 | 9.98 | 2940 | 5.02 | 0.54 | 3.59 | 35.90 |
| | 2.5 | 12.17 | 3870 | 4.72 | 0.27 | 3.86 | 38.56 |
| | 3 | 14.44 | 4040 | 4.91 | 0.13 | 3.99 | 39.87 |
| | 3.5 | 17.39 | 3910 | 5.03 | 0.13 | 4.12 | 41.18 |

Recovery of caffeine after cycle 2: 88.5%

The experimental procedure or arrangement of example experiment 4 corresponds to a process of the invention in which steps S2 (caffeine adsorption) and S3 (caffeine desorption) are performed alternately and repeatedly in succession. It has been found here that such a procedure for the process of the invention shows particularly good results especially with the adsorber resins [1] to [3] used here, i.e. with macroporous adsorber resins which are selected from the group consisting of polystyrene, polydivinylbenzene and copolymers thereof with one another and with other monomers, and which are nonfunctionalized and nonionic.

Both in the first and in the second loading cycle (in each case according to step S2 of the process of the invention), it was possible to bind a large amount of caffeine from the caffeinated extraction liquid used to the adsorber resin. For instance, the respectively maximum cumulative amount of caffeine adsorbed on the adsorber resin was 3.89 g (cycle 1) and 3.72 g (cycle 2) when adsorber resin [1] was used, 4.50 g (cycle 1) and 4.75 g (cycle 2) when adsorber resin [2] was used, and 4.23 g (cycle 1) and 4.12 g (cycle 2) when adsorber resin [3] was used. The respective maximum caffeine loading of the adsorber resins (total capacity in g/L) was 38.94 g/L (cycle 1) and 37.22 g/L (cycle 2) when adsorber resin [1] was used, 44.97 g/L (cycle 1) and 47.52 g/L (cycle 2) when adsorber resin [2] was used, and 42.30 g/L (cycle 1) and 41.18 g/L (cycle 2) when adsorber resin [3] was used. Caffeine adsorption performance in the first and second loading cycles is thus virtually identical. Suitable adsorber resins may thus be repeatedly utilized as “intermediate caffeine storage media” in a technically advantageous manner in a process of the invention.

The isolated instances of decline in caffeine loading at the end of particular cycles are possibly the result of measurement inaccuracies in a complex technical plant with multiple columns.

The recovery of caffeine by rinsing of the caffeine-laden adsorber resins using DCM (in step S3 of the process of the invention) after the first loading cycle was likewise at very high values of 93.6% (adsorber resin [1]) and 100% (adsorber resins [2] and [3]). A caffeine-laden adsorber resin can thus be rinsed (contacted) with dichloromethane in such a way that at least 90% of the caffeine is leached from the caffeine-laden adsorber resin into the dichloromethane.

The recovery of caffeine by rinsing of the caffeine-laden adsorber resins using DCM (in step S3 of the process of the invention) after the second loading cycle was also at high values of 82.4% (adsorber resin [1]), 84.7% (adsorber resin [2]) and 88.5% (adsorber resin [3]). Even in the case of repetitive performance of process steps S2 and S3, a caffeine-laden adsorber resin can be rinsed (contacted) for a second time with dichloromethane such that at least 80% of the caffeine is leached from the caffeine-laden adsorber resin into the dichloromethane.

A process of the invention can thus be performed efficiently so as to result in both decaffeinated green coffee beans and caffeine or caffeine extract as (separate) products.

### Example Experiment 5: Extraction of Caffeine from Caffeinated Green Coffee Beans with An Aqueous Extraction Liquid Such that Caffeine is Extracted from the Caffeinated Green Coffee Beans into the Extraction Liquid, Followed by Contacting of the Resulting Caffeine-Enriched Aqueous Extraction Liquid with an Adsorber Resin Such that Caffeine from the Extraction Liquid is Bound to the Adsorber Resin, and Contacting the Caffeine-Laden Adsorber Resin with Dichloromethane Such that Caffeine is Dissolved in the Dichloromethane

A reactor was initially charged with green coffee beans and water in a mass ratio of 1:1.27. This extraction mixture was heated to a temperature of 80° C. with a jacket heater and stirred for a period of 30 minutes. After a stirring time of 30 minutes, the resulting extraction liquid (liquid phase of the extraction mixture) was separated from the extracted green coffee beans and passed through two series-connected adsorber columns. The adsorber columns had a total volume of 2×400 mL=800 mL (=1 BV) and were each filled with 240 g of a macroporous adsorber resin without a functional group, nonionic, based on a divinylbenzene-crosslinked polystyrene (LEWATIT® VP OC 1064 MD PH from Lanxess). The volume flow rate was about 5 BV/h. After passage through the adsorber columns, the extraction liquid was passed back into the reactor to the (already partly extracted) green coffee beans remaining therein, and, after another extraction thereof, thence again through the adsorber columns (circulation system).

The caffeine content of the aqueous extraction liquid after one throughput of about 5 BV in each case (at time intervals of 30-60 minutes) was analyzed both before and after passage through the adsorber columns (see table 12). This was used to determine:
i) amount of caffeine adsorbed on the adsorber resin per pass of the respective BV,
ii) cumulative amount of caffeine adsorbed on the adsorber resin, and
iii) caffeine loading of the adsorber resin (mass of caffeine adsorbed per unit volume of adsorber resin in g/L).

In addition, a sample of the aqueous extraction liquid was taken at the start of the experiment and at the end of the experiment (after 6.3 hours), and the concentration of some standard coffee constituents was analyzed (see table 13).

After the experiment had ended, the caffeine-laden adsorber columns were rinsed with dichloromethane in order to desorb caffeine from the adsorber columns. Nearly 100% was recovered in the dichloromethane phase. In addition, the phase was analyzed for chlorogenic acids, asparagine, total dry residue (TDR), ash in the TDR, total fat, total protein and total sugar. The content of chlorogenic acids in the resulting dichloromethane solution was <2 ppm, asparagine<12.5 ppm, total fat<0.3 g/100 mL, total protein<0.5 g/100 mL and total sugar<0.5 g/100 mL. The TDR was 1600 mg/L, and the ash therein was 5.36%.

After the experiment had ended, the extracted green coffee beans were separated from the aqueous extraction solution and dried. The caffeine content of the extracted green coffee beans was analyzed and was 0.09%.

TABLE 12
Results of example experiment 5 - caffeine content of the aqueous
extraction liquid

| | | | | | Cumulative | |
|---|---|---|---|---|---|---|
| | | | | | amount | |
| | | | | Adsorbed | of | Caffeine |
| | | Caffeine | Caffeine | caffeine | caffeine | loading |
| | | content | content | per pass | adsorbed | of |
| Experi- | | before | after | of the | on the | the |
| ment | | both | both | respective | adsorber | adsorber |
| time | BV | columns | columns | BV | resin | resin |
| [h] | eluted | [mg/L] | [mg/L] | [g] | [g] | [g/L] |
| 0.0 | Stirring at 80º C. for 30 minutes without circulation | | | | | |
| 0.5 | 0.0 | 1930 | 0 | 0 | 0.00 | 0.00 |
| 1.8 | 6.1 | 1310 | 0 | 7.90 | 7.90 | 9.87 |
| 2.8 | 10.7 | 645 | 4 | 3.72 | 11.61 | 14.52 |
| 3.8 | 15.4 | 299 | 9 | 1.76 | 13.37 | 16.72 |
| 4.8 | 20.6 | 153 | 15.5 | 0.83 | 14.20 | 17.75 |
| 5.8 | 25.2 | 166 | 170 | 0.26 | 14.46 | 18.07 |
| 6.3 | 28.0 | 180 | 318 | −0.14 | 14.32 | 17.90 |

TABLE 13
Analysis of the concentration of some coffee constituents
in the aqueous extraction liquid at the start of the experiment
and at the end of the experiment (after 6.3 hours)

| Coffee constituent | Unit | At start of experiment | After 6.3 h |
|---|---|---|---|
| Caffeine | mg/L | 1930 | 318 |
| Asparagine | mg/kg | 200 | 200 |
| Total fat | g/100 g | <0.3 | <0.3 |
| Total protein | g/100 g | 0.65 | <0.5 |
| Chlorogenic acid | mg/L | 10017 | 8858 |

The experimental procedure or arrangement of example experiment 5 corresponds to a process of the invention in which steps S1 (caffeine extraction from green coffee beans by means of an aqueous extraction liquid) and S2 (caffeine adsorption from the aqueous extraction liquid using an adsorber resin) are performed repeatedly, and the aqueous extraction liquid is conveyed in circulation once or more than once. In this case, the caffeine-depleted aqueous extraction liquid that arises in step S2 or a processing product thereof is reused as aqueous extraction liquid in step S1.

The results of example experiment 5 show that it is possible by means of a process of the invention, in an efficient manner, to produce decaffeinated green coffee beans having a caffeine content of only 0.09%. In an advantageous manner, the green coffee beans do not come into contact here with organic solvents such as DCM; instead, caffeine is extracted exclusively by contacting with an aqueous extraction liquid.

In addition, example experiment 5 shows the efficiency of caffeine adsorption (in step S2 of the process of the invention) on macroporous adsorber resins which are selected from the group consisting of polystyrene, polydivinylbenzene and copolymers thereof with one another and with other monomers, and which are nonfunctionalized and nonionic (cf. adsorber resin [1] used here). The adsorber resin used here is capable of binding a particularly large amount of caffeine from a caffeinated aqueous extraction solution; cf. in particular the maximum cumulative amount of caffeine adsorbed on the adsorber resin of 14.46 g and the maximum caffeine loading of the adsorber resin of 18.07 g/L. The decline in caffeine loading between the times of 5.8 and 6.3 hours of the experiment is possibly the result of measurement inaccuracies in a complex technical system and/or the establishment of equilibria under the experimental conditions.

The adsorber resin used is additionally capable of selectively binding caffeine in a step S2 of the process of the invention. What is meant here by “selectively” is that other coffee constituents present in the aqueous extraction liquid, for example asparagine, fats, proteins, sugars and chlorogenic acids, do not bind at all or bind less strongly to the adsorber resin (cf. the values from table 13). This is particularly advantageous since substances of relevance for the sensory quality of coffee remain in the aqueous extraction liquid and hence a smaller amount of these substances is also extracted from the green coffee beans.

Moreover, the desorption of caffeine from an adsorber resin previously laden with caffeine and other coffee constituents with dichloromethane, such that caffeine is dissolved in the dichloromethane (as per step S3 of the process of the invention), is also effected very efficiently and selectively. The recovery of caffeine in the dichloromethane solution was very efficient and was 90.4%.

Example experiment 5 shows that, although a certain amount of chlorogenic acid binds to the adsorber resin (cf. the chlorogenic acid content in the aqueous extraction liquid at the start of the experiment of 10 017 mg/L and the chlorogenic acid content in the aqueous extraction liquid at the end of the experiment after 6.3 hours of 8858 mg/L), this amount of chlorogenic acid bound to the adsorber resin is not desorbed on contacting with dichloromethane. There was only<2 ppm of chlorogenic acid in the dichloromethane solution.

The adsorber resin can thus be reused (and repeatedly) (in steps S2 and S3 of the process of the invention) to (selectively) bind caffeine from an aqueous extraction liquid and then to release it (selectively) to dichloromethane. Experiment example 5 thus shows impressively that the invention in particular makes use of the technical fact that caffeine has comparatively moderate solubility in water (and therefore can be bound efficiently by an adsorber resin from aqueous solution) but has particularly good solubility in dichloromethane (and is therefore released efficiently by the adsorber resin to dichloromethane).

### Example Experiment 6

In example experiment 6, the procedure according to example experiment 5 was repeated a total of 13 times (13 loading and unloading cycles each according to steps S2 and S3 of the process of the invention), and the maximum caffeine loading of the adsorber resin in g/L and the recovery of caffeine in the dichloromethane solution in % were determined each time (cf. table 14).

TABLE 14

| | Maximum caffeine loading of | Caffeine |
|---|---|---|
| Cycle | the adsorber resin [g/L] | recovery [%] |
| 1 | 18.53 | 90.40 |
| 2 | 16.91 | 101.86 |
| 3 | 18.65 | 117.97 |
| 4 | 19.37 | 108.72 |
| 5 | 16.72 | not measured |
| 6 | 18.53 | 107.79 |
| 7 | 16.65 | 92.96 |
| 8 | 17.31 | 108.62 |
| 9 | 19.55 | 102.34 |
| 10 | 17.74 | 94.81 |
| 11 | 18.16 | 113.58 |
| 12 | 18.05 | not measured |
| 13 | 18.21 | 103.90 |

The recovery of caffeine here is in some cases above the theoretically possible value of 100%. This is probably because of customary measurement variances.

This experiment shows impressively that the adsorber resin can be repeatedly used to (selectively) bind caffeine from an aqueous extraction liquid (as per step S2 of the process of the invention) and then to release it (selectively) to dichloromethane (as per step S3 of the process of the invention).

1. A process for producing decaffeinated green coffee beans, comprising the following steps:
(S1) contacting an amount of caffeinated green coffee beans with an aqueous extraction liquid so as to extract caffeine from the caffeinated green coffee beans into the extraction liquid,
(S2) contacting the caffeine-enriched aqueous extraction liquid that arises in step S1 with an adsorber resin so as to bind caffeine from the extraction liquid to the adsorber resin, wherein the adsorber resin used is a macroporous adsorber resin selected from the group consisting of polystyrene, polydivinylbenzene and copolymers thereof with one another,
(S3) contacting the caffeine-laden adsorber resin that arises in step S2 with dichloromethane so as to dissolve caffeine in dichloromethane.

2. The process as claimed in claim 1, wherein an adsorber resin used in step S2 has been preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-containing extraction liquid that arises in step S1 to the adsorber resin.

3. The process as claimed in claim 1,
wherein the aqueous extraction liquid used in step S1 is
water
or
an aqueous solution comprising individual or multiple noncaffeine coffee constituents selected from the group consisting of acids, minerals, aromas, compounds convertible to aromas by Maillard reaction, and antioxidants, so as to hinder or prevent extraction of corresponding coffee constituents from the caffeinated green coffee beans into the extraction liquid.

4. The process as claimed in claim 1, wherein, in step S2,
the macroporous adsorber resin is a polystyrene or a copolymer of polystyrene, and/or
at least 90%, of the caffeine from the caffeine-containing extraction liquid is bound to the adsorber resin.

5. The process as claimed in claim 1, wherein, in step S3,
the contacting is performed in such a way that at least 80%, of the caffeine from the caffeine-laden adsorber resin is dissolved in the dichloromethane,
and/or
the temperature of the dichloromethane is lower than 35° C.

6. The process as claimed in claim 1,
wherein:
step S1 is performed in such a way that at least a predetermined amount of caffeine is extracted from the amount of caffeinated green coffee beans and/or
the decaffeinated green coffee beans that result from step S1 are dried.

7. The process as claimed in claim 1, comprising the additional step after step S3:
(S4) treating the adsorber resin
(S4-1) to remove dichloromethane
and/or
(S4-2) to regenerate the loadability of the adsorber resin with caffeine under the conditions of step S2,
wherein, in step S4-1, the treating of the adsorber resin to remove dichloromethane comprises one or more of the following measures:
treating the adsorber resin with liquid water or an aqueous solution so as to remove DCM from the adsorber resin,
treating the adsorber resin with steam, so as to remove DCM from the adsorber resin,
and wherein, in step S4-2, the treating of the adsorber resin to regenerate the loadability of the adsorber resin with caffeine under the conditions of step S2 comprises the following measure:
treating the adsorber resin with an aqueous alkaline solution.

8. The process as claimed in claim 1,
wherein:
the contacting in step S2 comprises flow of the caffeine-enriched aqueous extraction liquid that arises in step S1 over the adsorber resin and/or
the subsequent contacting in step S3 comprises flow of dichloromethane over the caffeine-laden adsorber resin.

9. The process as claimed in claim 1,
wherein:
the progress attained in the extraction in step S1 and/or the loading of the adsorber resin with caffeine attained in step S2 is determined and
the process moves from step S2 to step S3 as soon as a predetermined progression of the extraction in step S1 has been attained and/or as soon as a predetermined loading of the adsorber resin with caffeine in step S2 has been attained, and/or
wherein aqueous extraction liquid is circulated once or more than once.

10. The process as claimed in claim 1,
wherein the process is a process for producing decaffeinated green coffee beans and caffeine concentrate, comprising the additional step of:
(S5) obtaining caffeine concentrate from the solution of caffeine in dichloromethane after step S3.

11. An apparatus for production of decaffeinated green coffee beans, comprising
an extractor fillable with an amount of green coffee beans for contacting the amount of caffeinated green coffee beans with an aqueous extraction liquid,
an adsorption unit containing an adsorber resin, wherein the adsorber resin is a macroporous adsorber resin selected from the group consisting of polystyrene, polydivinylbenzene and copolymers thereof with one another, for contacting an aqueous, caffeine-enriched extraction liquid with the adsorber resin, wherein the extractor is connected to the adsorption unit such that aqueous, caffeine-enriched extraction liquid can be passed from the extractor into the adsorption unit,
wherein an adsorber resin is used that has been preladen with individual or multiple noncaffeine coffee constituents selected from the group consisting of acids, minerals, aromas, compounds convertible to aromas by Maillard reaction, and antioxidants,
a reservoir vessel for aqueous extraction liquid, connected to the extractor such that aqueous extraction liquid can be passed from the reservoir vessel for aqueous extraction liquid into the extractor,
a reservoir vessel for dichloromethane, connected to the adsorption unit such that dichloromethane can be contacted with the adsorber resin,
one or more control devices
for controlling the supply of aqueous extraction liquid and/or of dichloromethane within the apparatus.

12. The apparatus as claimed in claim 11,
wherein the apparatus is set up to convey an aqueous extraction liquid in circulation, wherein the extractor and the adsorption unit are part of the circuit,
and/or
having a separation unit for separation of caffeine from a solution of caffeine in dichloromethane,
wherein the apparatus is set up to convey dichloromethane from the reservoir vessel for dichloromethane to the adsorption unit and thence to the separation unit, and/or
wherein
the extractor has been filled with green coffee beans,
the reservoir vessel for aqueous extraction liquid contains an aqueous extraction liquid,
the reservoir vessel for dichloromethane contains an amount of dichloromethane and/or
the macroporous adsorber resin is a polystyrene or a copolymer of polystyrene.

13. A method of removing caffeine from an adsorber resin laden with caffeine and further coffee constituents, comprising:
contacting a caffeine-laden adsorber resin with dichloromethane such that caffeine is dissolved in the dichloromethane,
wherein the adsorber resin is a macroporous adsorber resin selected from the group consisting of polystyrene, polydivinylbenzene and copolymers thereof with one another.

14. A method of using an adsorber resin,
wherein the adsorber resin is a macroporous adsorber resin selected from the group consisting of polystyrene, polydivinylbenzene and copolymers thereof with one another, the method comprising:
adsorbing caffeine from a caffeine-enriched aqueous extraction liquid in a process for producing decaffeinated green coffee beans, wherein the caffeine-laden adsorber resin with caffeine extracted from the green coffee beans is treated with dichloromethane such that caffeine is dissolved in dichloromethane.

15. The method of using an adsorber resin as claimed in claim 14, wherein the adsorber resin used has been preladen with individual or multiple noncaffeine coffee constituents selected from the group consisting of acids, minerals, aromas, compounds convertible to aromas by Maillard reaction, and antioxidants, so as to hinder or prevent binding of corresponding coffee constituents from the caffeine-containing extraction liquid that arises in step S1 to the adsorber resin.
